(19) United States
(12) Patent Application Publication
(10) Pub. No.: US 2022/0046767 A1
(43) Pub. Date: Feb. 10, 2022

(54) POINT-OF-USE INDUCTION WATER HEATER

(71) Applicant: PRE TECHNOLOGIES LIMITED, London (GB)

(72) Inventor: Luis Seguí Díaz-Pache, London (GB)

(21) Appl. No.: 17/281,350

(22) PCT Filed: Aug. 14, 2019
(86) PCT No.: PCT/EP2019/071883

§ 371 Date: Mar. 30, 2021

(30) Foreign Application Priority Data
Oct. 11, 2018 (GB) 1816593.6

(51) Int. Cl. H05B 6/10; F24H 1/10; H05B 6/42; F24H 9/00

(52) U.S. Cl. CPC H05B 6/108; F24H 1/101; F24H 2250/08; F24H 9/0021; H05B 2206/024; H05B 6/42

(57) ABSTRACT

A point of use induction water heater has a water receiving space arranged between an inlet and outlet, and at least one inductor coil disposed in the water receiving space, arranged to become submerged by water flowing between the inlet and outlet. At least one conductive body is also contained in the water receiving space, and arranged to be inductively heated by the inductor coil upon driving of the coil with a current.

### FIELD OF THE INVENTION

This invention relates to an induction water heater, and in particular to a point-of-use induction water heater.

### BACKGROUND OF THE INVENTION

Water heating systems, both domestic and industrial, come in two main varieties: centralized water heating systems, and point of use systems. Centralized heating systems are based on heating water at a central location, e.g. at a central boiler, and then transporting the heated water to various hot water supply or outflow points in a building. Point of use systems are based on use of inline heating units installed directly adjacent each hot water supply point, and configured to heat water instantaneously as it is needed.

Centralized systems may make use of for instance gas or electric (Ohmic) power to heat water. Both gas and electric based point of use heating devices are also known.

Centralized systems have numerous known disadvantages including water wastage and significant energy inefficiency, both in the heating of water, and more importantly in the transportation of heated water from the central heating point to supply points. Water is wasted as the water backed up in the connecting pipes between the point of use and the central heater must typically first be flushed through before fresh hot water reaches the outlet. Energy is wasted as heat is lost from the water as it passes through connection pipes from the central heater to the supply point.

Energy is also wasted by hot water backed up in the connection pipes to the outlet after drawing hot water for use. After drawing hot water, a large amount of hot water remains in the pipes (between 2 and 5 litres typically, at a temperature of 45-50° C.). The heat energy in this backed up water is lost as it leaks out through the pipes to the environment.

It is estimated that consumers may waste up to 10000 litres of water per year and up to 600 kWh per year due to the above inefficiencies.

In addition, the initial flush through of water causes an inconvenient delay for users, typically having to wait 10-20 seconds before sufficiently hot water is obtained. More generally, centralized systems also require installation of a hot water circuit running throughout a building to facilitate supply (which incurs initial infrastructure costs, and also difficulties with maintenance and reliability).

Centralized systems often make use of a tank-storage arrangement, wherein the system maintains a certain volume of water heated and stored in a tank ready for use. This leads to further inefficiencies as the volume of stored water must be continually re-heated, or topped up with heat, to compensate for heat lost as the water is held in the tank. Further inconvenience for the user may also be caused as upon consumption of the stored volume of hot water, a long delay follows as a user must wait for a further volume of water to be heated and stored for use.

Point-of-use based heating systems ameliorate many of the problems associated with centralized systems. In particular, due to the proximity of the water heating unit to the water outflow point, heat loss through transfer of the water to the outlet point, and also the water and heat waste through the need to flush backed up cool water through the system are substantially avoided. Delay times for fresh hot water to flush through to the supply point are also much reduced. Many of the inefficiencies associated with tank based solutions are avoided as a volume of hot water is not kept stored and topped-up for long periods.

However, currently available point of use technology is not well-developed. Known devices carry significant disadvantages which have discouraged their widespread adoption.

In particular, achieving the necessary heating power to enable reliable instantaneous hot water supply at each and every outlet has so far proved either impractical or unviable in terms of cost.

In particular, two main point-of-use technologies are currently known: gas-based heating solutions and electric (Ohmic) heating solutions.

Gas based solutions require installation of a separate gas supply pipe to each and every water outlet, to separately feed each point of use unit. This is impractical and incurs significant initial costs.

Electric (Ohmic) solutions are well-known and commonly implemented for specific applications, such as to supply power showers.

However, their widespread use throughout a building as a sole source of hot water is currently rendered impractical for a number of reasons. First, the available power output is relatively low, between approximately 3 and 11 kW. This limits the flow rate of water which can be heated.

More significantly however, the energy consumption of Ohmic heaters is extremely high, due to relatively poor energy efficiency.

Furthermore, the resistance-heating operation of Ohmic heaters typically necessitates complex or intricate resistance routings, leading to relatively large or bulky heater units. There are also known reliability problems for Ohmic heaters due to limescale build-up on the heating element which decreases thermal performance and corrodes the element, eventually leading to failure.

Known point of use heating technology is hence currently only practical for supplementing a centralized heating system.

Induction based heating is also known for centralized water heating systems. However, known induction heating solutions are limited in terms of achievable power output, and are also currently very energy inefficient for use over a continuous period. They also suffer from the same problems as all centralised systems, e.g. large heat loss in transferring water to remote supply outlets.

In summary, the main disadvantages associated with known water heating systems include:
water waste, due to the need to flush cooled water through the system before hot water reaches an outlet;
energy waste, due to the loss of heat as water is transferred from a central heater or stored in a central tank, and also from hot water left backed up in supply pipes after draw from an outlet;
waiting time, as the cooled water is flushed through the connecting pipes, and hot water makes its way to the outlet; and
high energy consumption and reliability and cost issues of known point of use solutions.

It is an aim of present invention to provide an improved water heating solution capable of mitigating some or all of the above described problems.

### SUMMARY OF THE INVENTION

The invention is defined by the claims.

According to examples in accordance with an aspect of the invention, there is provided a point of use induction water heater for installation in-line with a water supply pipe, for heating water flowing through the unit between an inlet and an outlet, the water heater comprising:

a water receiving space arranged between the inlet and outlet;

at least one induction coil contained in the water receiving space and arranged for making contact with and to be submerged by water flowing in use between the inlet and the outlet; and

at least one electrically conductive body contained in the water receiving space, and arranged for magnetic inducement therein of electrical currents through driving of the inductor coil, the electrical currents for heating the conductive body, to thereby heat water flowing in use between the inlet and outlet.

The invention hence makes use of induction heating technology within a point of use heating unit. However, to improve energy efficiency over known induction technology, advantageously, the induction coil itself is disposed in contact with flowing water. This has been found to lead to surprising benefits in terms of energy efficiency, as explained below.

When current is driven through any conductor, including the inductor coil, Joule heating occurs in the conductor body. Normally in induction heaters, the heat generated in the inductor coil is wasted, and its generation reduces energy efficiency of the heater. Moreover, the generated heat incurs added problems as the heat must be dissipated or means provided to cool the coil, e.g. a heat sink or other cooling means.

According to embodiments of the present invention, both problems are resolved by locating the coil inside the water flow space of the heater. By locating the induction coil in a flow path between the inlet and outlet, the coil makes contact with water flowing through the heating unit. In this way, heat internally generated within the inductor coil can be directly transferred to passing water, thus utilising this energy for contributing to heating the water, and also avoiding the need for auxiliary heat dissipation means (as the water itself provides the heat dissipation function). In this way, efficiency of the water heater is increased, and bulky heat sinks avoided.

It has not previously been considered to locate the inductive coils within the water receiving space itself. This may be partly because it is mechanically more straightforward to provide the electrically powered coil outside of the water (avoiding the need for water insulation around electrical cables/components). The magnetic induction mechanism by its nature allows for ‘remote’ heating of conductive bodies inside the heating space by means of this coil located outside of the chamber.

However, the applicant has found the surprising result that the Joule heat generated by the coil itself can contribute up to 25% additional heat to passing water compared to the inductively generated heat alone. This very significantly increases the efficiency of the water heater compared to known inductive water heating units.

The large contribution to the heating effect is at least partly due to the naturally very efficient heat transfer between the conductive coil and the water passing it. Almost 100% of generated Joule heat is transferred to the water.

The at least one electrically conductive body included in the water receiving space acts as the target of the at least one inductor coil. Electrical eddy currents are induced in the conductive body upon electrical driving of the at least one inductor coil (driving the coil with an alternating current).

The heater of the invention is a point of use water heater. The heater is designed to heat water as it flows through the unit. The water receiving space forms a water flow space through the heater, through which water flows between the inlet and outlet, the water being heated as it flows. Water is preferably not held or stored in statis in the water receiving space for the purpose of heating it. Heating may be substantially instantaneous for instance. The water receiving space forms a water heating space for instance.

The at least one inductor coil is arranged to be (fully) submerged by water received in the water receiving space in use. This means that the at least one inductor coil is arranged so that water flowing between the inlet and outlet surrounds the coil, e.g. on all sides.

Submergence maximizes heat transfer between the coil and the water. The coil may be completely surrounded or covered by the water, e.g. surrounded on all sides by the water.

The coil is arranged to make contact with water passing in use between the inlet and the outlet. More particularly, a conductive wire or winding forming the coil may be arranged to make contact with water flowing between the inlet and outlet.

The coil is arranged for thermally communicating with water flowing in use between the inlet and outlet, i.e. the coil is arranged to make thermal contact or coupling with water flowing in use between the inlet and the outlet.

In particular, the coil may be formed of a spiral or helical conductive winding. Said conductive winding may be arranged to make contact with the water.

According to one or more examples, there may be water flow spaces between windings of the coil. The flow spaces are for receiving water flowing in use over the coil between the inlet and the outlet. The coil may hence be structured having axial spacings between neighbouring windings (i.e. turns) of the coil (i.e. the windings or turns are axially spaced from one another). This means that water flowing through the water receiving space is able to make contact with the conductive wire of the coil on all sides, including axially top and bottom surfaces of coil turns. This increases heat transfer efficiency from the coil to the water.

According to one or more embodiments, there may be at least one water flow channel defined in the water receiving space, having a water flow direction, the at least one inductor coil disposed in said flow channel and arranged to be submerged by water flowing in use through the channel in said flow direction. Submerged means surrounded by water on all sides.

In this example, the coil is arranged in a single-directional water flow path, with water flowing past and around the coil on all sides.

When a wire or conductor is driven with a high frequency alternating current, a so-called skin effect occurs, wherein current density through the wire is concentrated at a radial periphery of the wire. This has the effect that Joule heating in the wire is maximized at regions toward the radial periphery, i.e. toward the radial outer surface (or ‘skin’) of the wire.

This has two effects. First, the maximum temperature to which the wire is heated is increased as the current is concentrated in a smaller volume toward this periphery, instead of across the whole wire cross-section. Secondly, due to concentration of Joule heating at the periphery, heat transfer out of the wire (both radiative, convective and conductive), is increased as more of the heat is concentrated at areas more thermally proximal the radial surface.

In typical inductive heating devices, both of these effects are problematic for the inductor coil, as they increase the burden on heat dissipation means for keeping the coil cool.

According to embodiments of the present invention, these effects are beneficial, since the heat is actively used for the heating of the water and hence enhanced thermal transfer out of the wire is advantageous.

According to one or more particular examples, the at least one inductor coil may be driven with an alternating current having frequency of at least 10 kHz, preferably at least 20 kHz, more preferably at least 40 kHz, even more preferably at least 60 kHz, for example at least 80 kHz.

As noted above, in typical inductive heating devices, it is desired to minimize the above-described skin-effect in the inductor coil, in which current is concentrated toward a radial surface of the inductor coil wire. At least partially for this end, typically copper is used for the coil. Copper has high electrical conductivity and is non-magnetic. These two properties minimize the skin effect.

According to embodiments of the present invention, it may be beneficial to enhance the skin effect. At least partially for this purpose, according to one or more embodiments, the inductor coil and/or the electrically conductive bodies may be formed from a magnetic stainless steel material, e.g. martensitic or ferritic stainless steel.

According to one or more embodiments, an outer housing enclosing the water receiving space may act as one of the at least one electrically conductive bodies arranged to be inductively heated by the at least one induction coil.

In some examples for instance, the water receiving space may be enclosed by an electrically conductive housing, an interior surface of the housing arranged to contact water passing through the water receiving space between the inlet and the outlet, and the housing arranged to be inductively heated in use by the at least one inductor coil upon driving of current through the coil. At least a portion of the housing should be electrically conductive for example. By enclosed by the outer housing may be meant bounded by the housing or for instance defined by an interior cavity of the housing.

According to one or more embodiments, the water heater may comprise a plurality of inductor coils of different outer diameter, coaxially arranged with respect to one another. By outer diameter is meant the diameter of the overall helix or spiral shape formed by the coil, i.e. helical diameter.

Since the coils are located within the water receiving space, it is rendered easier to provide multiple coils (and thereby enhance achievable heating power) since these can be arranged in a space efficient co-axial arrangement within the water receiving space. Such a co-axial arrangement is not possible where the coils are confined to an exterior of the chamber.

More particularly, there may be delimited in the water receiving space a co-axial arrangement of annular flow channels, and the plurality of inductor coils being disposed in separate of said annular flow channels. For example, a respective one of the plurality of inductive coils may be disposed in each annular flow channel.

Each inductor coil may be arranged to be submerged by water flowing through the respective flow channel in which it is disposed. Each inductor coil may be arranged in the respective one of the flow channels such that water flowing through the channel flows on both (radial) sides of the coil winding. The coil may be arranged such that the water flowing through the channel flows in the same direction on both radial sides of the coil windings.

Each inductor coil may in examples be (radially) offset from both (radial) sides of the channel in which it is disposed.

The annular flow channels are divided or separated or partitioned from one another for example. Suitable barrier or baffle members may be provided for this purpose for instance. Preferably the flow channels are separated by electrically conductive partition members. Conductor tubes may be provided for this purpose, as detailed further below.

By providing the coils in separate annular flow channels, efficient transfer of the generated coil Joule heat to the water is facilitated. Each coil transfers this heat to water flowing through its respective flow channel.

The water heater may comprise a plurality of co-axially arranged electrically conductive tubes of different diameter, annular spaces between neighbouring conductive tubes forming said arrangement of annular flow channels, and the plurality of inductor coils being disposed in separate of the formed annular flow channels.

In this arrangement the water receiving space is divided into the plurality of annular flow spaces by a co-axial arrangement of conductive tubes.

The conductive tubes provide at least a subset of the at least one electrically conductive body required by the main invention. The conductor tubes are electrically conductive tubular bodies. The conductor tubes provide target(s) of the inductive heating.

The terms ‘conductive tubes’ and ‘conductor tubes’ may be used interchangeably in this disclosure.

This set of one or more embodiments provides an arrangement of coaxially interleaved or inset conductive tubes and inductor coils.

By disposing the conductor tubes co-axially inset between inductor coils, maximally efficient inductive heating of the conductor tubes is realised. This is because the conductor tubes are each placed in close proximity and slightly radially offset from a given inductor coil. This generally corresponds to a region of maximal magnetic field density around the inductor coil, since it is a region where circulating magnetic fields of each coil loop most strongly combine and reinforce. The co-axial positioning thus allows each conductor tube to be located at this maximal field region, maximizing magnitude of induced eddy currents.

Furthermore, since the coils are located in the water heating space itself, this allows for each and every one of the plurality of tubes to be placed in close radial proximity to a respective coil, allowing every conductor tube to benefit from maximized heating. Overall heating efficiency of the device is therefore increased. This is not possible when coils are confined to an exterior to the water chamber since this exterior placement limits a degree of proximity of the coil to target conductor bodies placed inside the water chamber. Each further co-axial body is at increased radial distance from the coil and hence within a weaker field region. Furthermore, any more radially outward conductor bodies will at least partially shield more radially inward bodies from the generated magnetic fields, inhibiting or even completely preventing inductive heating of these inner bodies.

Furthermore, placing coils coaxially between adjacent tubes allows that at least a subset of the tubes is located sandwiched between a co-axial pair of coils. At this region, the field strength is further enhanced by the constructive superposition of the fields generated by the two radially neighbouring coils (so long as the current driven through the two coils runs in circumferentially opposite directions). Hence a positive proximity effect is achieved, enhancing heating of the sandwiched conductor tube.

Furthermore, with this arrangement, maximal heat transfer is achieved. This is because each heated conductor tube is placed in direct fluid contact with flowing water passing though the annular channels, and each inductor coil is placed in fluid contact with the flowing water. Hence heated surfaces of all parts are making direct contact with flowing water. The water is heated on each radial side of the channel by the faces of the conductor tubes, and is further heated at a central region of the channel by the inductor coil surface.

According to one or more advantageous embodiments, one of said plurality of electrically conductive tubes may define a portion of an outer housing enclosing the water receiving space.

For example, a housing enclosing the water receiving space may comprise an electrically conductive tubular body covered at each end by a cover member, and wherein said tubular body forms one of said co-axially arranged conductive tubes.

According to any example disclosed herein, the plurality of inductor coils may be electrically supplied such that a current through radially neighbouring coils runs in circumferentially opposite directions. As noted above, this allows that in a radial space between co-axially adjacent coils, the magnetic fields generated by the two coils constructively interfere. This thus allows target conductor tubes positioned between the coils to be located in regions of maximal field strength. Inductive heating of the conductor tube is thus maximised.

The annular flow channels may be connected in fluid series with one another, to define a single continuous flow path between the inlet and outlet of the heater via said plurality of connected annular flow channels.

The annular flow channels are thus linked in series to define a continuous fluid path from the inlet to the outlet. They may be connected for instance end to end to define a single continuous flow path.

By defining a single flow path, total possible heat transfer to water flowing through the unit can be increased, since the same water passes through multiple heating flow channels, each channel providing contact with a respective inductor coil and/or heated conductor tubes.

According to one or more examples, the annular flow channels may be connected so as to define a labyrinthine flow path between the inlet and outlet via said annular flow channels.

For example, the annular paths may be connected end to end in series, thus defining a labyrinthine flow path.

A labyrinthine flow path increases water agitation, or turbulence, as the water passes through the heating unit. This is beneficial for encouraging mixing or churning of the water, so that transferred heat is quickly spread evenly throughout the depth of the water to maximize continued heat transfer into the water (i.e. to avoid build-up of hot water only at the water-inductor and water-target interfaces).

According to one or more embodiments, an annular cross-section of each of the arrangement of annular flow channels may be adapted so as to provide uniform flow velocity through each channel, i.e. the annular cross-sections of the flow channels may be configured such that a water flow speed or velocity is the same through every channel. The annular cross-section refers to the cross-sectional area through a given channel across the plane parallel with the annular radius of the channel, i.e. across the plane perpendicular to axial length of the channel, or, equivalently, the water flow direction through the channel.

This provides a uniform pressure drop across each channel of the heater device, so equalizes pressure drop through all sections of the heating space. The arrangement also provides a uniform heat transfer in each channel.

To facilitate this common flow speed through each channel, the annular flow channels may in particular be configured having a common or uniform annular cross-sectional flow area, i.e. the annular flow channels each have the same annular cross-sectional flow area.

The cross-sectional flow area means the cross-sectional area through each annular channel through which water flows in use. The cross-sectional flow area may be equal to the total annular cross-sectional area minus the cross-sectional area occupied by the respective inductor coil in the given flow channel.

According to one or more embodiments, the arrangement of annular flow channels may be arranged extending circumferentially around an inner axial flow channel, the axial flow channel fluidly connecting the arrangement of annular channels to the outlet of the heating unit.

This provides a space efficient flow channel arrangement.

The inner flow channel may extend axially through a middle of the arrangement of annular flow channels, e.g. centrally through the middle of the annular flow channels.

A radial outer-most of the annular flow channels may be fluidly connected to the inlet of the water heater.

According to one or more embodiments, the plurality of inductor coils may be electrically connected together in series. This enables driving of all of the coils simultaneously, and in-phase with one another, with a single drive signal for instance.

According to one or more embodiments, the heater may further comprise an electrically insulative outer casing. This may for example be arranged around an electrically conductive housing provided enclosing the water receiving space. It may be wrapped around the housing for example. It may be in direct contact with the electrically conductive housing, or one or more other layers or components may be located intermediate the casing and the housing, such as one or more capacitors.

According to one or more advantageous embodiments, the water heater may further comprise a capacitor electrically coupled with the inductor coil, to thereby form a resonant circuit comprising the inductor coil and capacitor, the resonant circuit having an electrical resonance frequency. For ease of reference, this capacitor may be referred to herein as a resonant capacitor. This refers to a capacitor forming part of said resonant circuit with the at least one inductor coil.

The coupled coil and capacitor together form a resonant LC circuit.

Coupling the coil with a capacitor to form a resonance circuit significantly increases electrical efficiency of the device. In use, energy can oscillate or resonate back and forth between the storage capacities of the coil and the capacitor. This means that energy input into the inductive coil (to drive generation of a field) is not lost upon its discharge from the coil. Instead the energy is transferred to the capacitor before being discharged back again to the inductor coil. Only ‘top-up’ energy need be supplied to the circuit, to compensate the energy actively transferred into the conductive bodies by magnetic induction, and resistive losses in the wires.

The resonance frequency is a function of both the capacitance, C, of the capacitor and the inductance, L, of the inductor. The resonance angular frequency, coo, in a simple circuit may for instance be determined from the standard equation ω₀=1/\sqrt{LC}, where C is capacitance of the capacitor and L is inductance of the inductor coil.

Resonance of the circuit, and thus the energy conservation, is only achieved when the circuit is driven at its resonance frequency.

In accordance with one or more embodiments, the heating unit may further comprise a generator adapted to drive the inductor coil at said resonance frequency, i.e. drive the coil with an alternating current electrical drive signal having a frequency equal to said resonance frequency.

However, there are different options as to how the electrical drive signal for the at least one coil is generated and supplied.

In one set of embodiments, the water heater may be configured as a standalone heater, configured to receive an AC mains power input supply, and comprising all components necessary to process and transform said supply into a suitable AC drive signal having a frequency matching the above-mentioned resonance frequency for driving the at least one coil at the resonance frequency. By way of example, this may include an AC-DC rectifier, a bank of DC smoother capacitors and a DC-AC inverter (formed for example by a set of transistors or IGBTs arranged in for instance H-Bridge configuration), which will turn the rectified DC power into the desired frequency AC drive signal. In this case, the heater may be understood as having a local generator for generating the AC drive signal for driving the one or more coil, since it comprises locally all components necessary to generate the drive signal.

Alternatively, the water heater may be configured for use within a wider water heating system wherein one or more of the electrical components for generating the drive signal are located remote from the heater itself, i.e. away from the point of use location at which the heater is installed, for example located at a convenient central remote location.

For instance, the water heater may be configured to be suitable for use within a water heating system which comprises a generator arrangement located remote from each of one or more point of use heaters (for example remote from the point of use area of each heater unit), and wherein this central generator performs some or all of the electrical processing required in generating the drive signal for supply to the at least one inductor coil, for driving the coil at resonance. This may carry safety benefits, since a very high amperage mains supply does not need to be provided separately to the point of use location of each point of use heater comprised by the system. A single mains supply can for example be routed to just the single central generator, and the electrical supply feed to each heater can be a transformed signal of lower current for example. This means for example that higher power currents are isolated at the remote or central generator away from the point of use.

In accordance with one set of embodiments, a water heater may be provided to have a power input connector for receiving an AC electrical drive signal from outside the heater having a frequency matching said resonance frequency, and the heater configured to provide said received drive signal to the resonant circuit, for driving the least one inductor coil at said resonance frequency. In some examples, the power input connector may be a connector extending from outside an outer housing or casing of the heater to inside the housing or casing of the heater.

A water heater in accordance with this set of embodiments would be suitable for instance for use within a water heating system comprising a separate remote generator arrangement which is configured to output an AC electrical drive signal at the resonance frequency of the heater resonant circuit. Hence in this example, all of the processes for generating the drive signal are assumed to have been already carried out outside of the heater, for instance at a remote generator, or at any other auxiliary generator. The heater hence preferably does not include any DC-AC power conversion means between the power input connection and the resonant circuit. The drive signal received at the power input connection may be delivered to the resonant circuit without any further power conversion or transformation. For example, the drive signal received at the power input connection may be delivered to the resonant circuit without DC-AC conversion. The heater also preferably does not comprise an AC-DC conversion means for converting an input AC supply into an initial rectified DC signal.

This arrangement is beneficial as the heater device located at the point of use may comprise fewer components, for instance only the proximal electrical components required for the heating: the inductor coil and, in some proposed embodiments, the resonant capacitor. This reduces the overall size of the heater unit.

In accordance with an alternative set of embodiments, the water heater may comprise a power input connector for receiving a DC power input from outside the heater,

the heater comprising a local DC to AC conversion means arranged to receive and transform the DC power input into an AC electrical drive signal for driving the at least one inductor coil, and

the heater arranged to provide said AC electrical drive signal to the resonant circuit for driving the at least one inductor coil.

Hence in this set of embodiments, the heater unit is suitable for receiving a rectified DC power input signal, and the heater itself comprises local means for converting this DC signal into the AC drive signal for driving oscillation of the at least one inductor coil. This heater may be suitable for use for instance within a heating system having a remote generator in which the remote generator for example processes an incoming mains supply into a rectified DC signal, and then supplies this DC signal as a DC power input signal for each of one or more point of use heaters comprised by the system.

In preferred examples, said AC electrical drive signal generated by the local DC-AC conversion means has an AC frequency matching (or substantially matching) the resonance frequency of the inductor coil resonant circuit. This is the most efficient and safe configuration.

The heater in this set of embodiments hence preferably does not comprise any AC to DC conversion means between the input connection and the DC-AC conversion means. The heater is configured to receive a DC power supply signal from outside the heater.

The DC to AC conversion means may be located inside an outer housing or casing of the heater, the housing or casing incorporating the water receiving space, such that the power input connector may extend from outside the outer housing or casing to inside the outer housing or casing. For example, the heater may comprise an electrically insulative outer casing as an outermost covering of the heater and wherein the power input connector extends from outside said insulative outer casing to inside. Alternatively, the DC to AC conversion means may be located just outside of the heater outer housing or casing. It may be physically coupled to the heater housing for instance via a frame or support structure, and electrically connected to the resonant circuit inside the housing. In either case, the DC-AC conversion means is located at the point of use heater, local to the heater housing containing the water receiving space.

Hence, in this set of embodiments, the elements transforming the DC power into high frequency AC are located in close proximity or within the point of use heater unit. This carries the advantage that the high frequency alternating electrical signal transmission is limited to the point of use area, more preferably to inside the heater enclosure.

This overcomes a potential drawback of alternative arrangements, wherein the high power and high frequency electrical alternating drive signal has to be transported from the centralised generator unit to one or more individual point of use heaters. This may result in potential hazards if the cable connecting the remote generator and the point of use heaters is not properly shielded to electromagnetic fields, as the radiated field may undesirably interact with the surroundings. This might result in electromagnetic noise being induced in electronic or electrical devices located in the vicinity of the cables and/or induce heat in conductive elements located in close proximity to the cable. In accordance with the above set of embodiments, the AC drive signal is confined to the point of use location of the heater itself.

The DC-AC conversion means may comprise one or more transistors, the transistors preferably being insulated gate bipolar transistors (IGBTs). The DC-AC conversion means preferably comprises a plurality of transistors, for example connected in H-bridge configuration.

The DC power input signal may be a pulsed DC power input signal, and the DC-AC conversion means configured for transforming said pulsed DC power input signal into said AC drive signal for driving the at least one inductor coil at said resonant frequency. The DC pulsating form limits the potential external electromagnetic induction hazard.

In accordance with further advantageous embodiments, the water heater may comprise an electrical filter means electrically connected between the DC-AC conversion means and the power input connector, adapted to inhibit transmission of AC signal components from the DC-AC conversion means toward the input connector.

The role of this filter means is to filter the high frequency pulsations generated by the DC-AC conversion means, isolating these from the power input connector, and in use, any electrically upstream components, such as a generator. This has the effect that the high frequency pulsations will be filtered out from electrically upstream sections of the power input line. For example, in cases in which the heater is connected to a remote generator which outputs the DC power supply signal, the high frequency pulsations are filtered from the connecting cable, and from internal electrical components of the generator itself. As a result, a stable, non-pulsating DC electrical signal will then be transported through the cable connecting such a generator and the point of use heater.

This is advantageous since high frequency pulsation, despite its DC nature (non-alternating), may induce noise and/or heating into the surrounding equipment and structures.

By providing a filter means, this advantageously avoids the need for instance for specially shielded or coaxial cables. This innovative step may thus reduce the complexity and cost of a power input cable supplying each point of use heater, for example fed from a remote generator, and also makes the heater safer to operate as only DC voltage and DC current will be transported through the feed cables. All high frequency alternating currents will be limited to the point of use area or, more advantageously, to the point of use water heater enclosure, away from the user and for example shielded to electromagnetic emissions.

Preferably the electrical filter means comprises one or more filter capacitors.

In accordance with one or more examples, the DC-AC conversion means and/or any other component for use in generating the AC drive signal for driving the inductor coils may be arranged in thermal communication with the water heater unit, for example with a section of the external surface of the water heater outer enclosure.

In accordance with one or more embodiments, the water heater may include a heat dissipation means thermally coupled to the DC-AC conversion means, and adapted to dissipate heat generated by the DC-AC conversion means.

Dissipate in this context means transfer heat out or away from the DC-AC conversion means. The heat dissipation means may for example be passive, e.g. a heat sink, and/or active, e.g. a fan or other cooling element.

In accordance with one or more embodiments, the DC-AC conversion means may be arranged in thermal communication with the water receiving space, for transferring heat to water flowing through said water receiving space between the inlet and outlet. The DC-AC conversion means may be electrically insulated from the water receiving space but thermally coupled.

In advantageous embodiments, the DC-AC conversion means may be arranged in thermal communication with the water receiving space via a heat transfer element having at least a portion arranged for making contact with (or optionally being submerged by) the water flowing in use between the inlet and the outlet.

This arrangement achieves two advantages. First, this negates the need for any additional heat dissipation means for the DC-AC inverter. Secondly, the heat generated by these components (typically wasted in known devices) is beneficially used to contribute to the in-line heating of the water.

The heat transfer element may for example comprise a thermally conductive structure or body. It may for example comprise a heat sink.

In accordance with one or more embodiments, the heat transfer element may be shaped to define a central bore, and arranged such that the bore defines a water flow channel arranged for receiving water flowing between the inlet and the outlet, for transferring heat from the DC-AC conversion means to the water passing through the channel.

The water heater may comprise an electrically insulative outer casing, encasing (for example containing or incorporating or enclosing or covering) the water receiving space, and the resonant capacitor (the capacitor comprised by the resonant circuit) being contained within the casing. For example the capacitor may be contained or disposed in an interior cavity defined within said outer casing.

The capacitor may either be provided disposed in the water receiving space, in fluid contact with water flowing though the space, e.g. submerged in the water, or may be arranged fluidly isolated from the water but housed within the outer casing.

By locating the capacitor within the insulative outer casing, all of the electrical reactive power is safely confined within the outer casing. The only power which need be supplied from outside the heating unit outer casing is for example that required to ‘top-up’ the resonant circuit with power lost through actual heating of the water and those required to initially charge the resonant circuit (‘active’ power).

Confining the high reactive power inside the insulative casing significantly improves electrical safety, as this is safely electrically isolated from users.

According to advantageous examples, the resonant capacitor (the capacitor forming part of the resonant circuit with the at least one inductor coil) may be arranged in thermal communication with the water receiving space for transferring heat to water flowing through said space between the inlet and outlet.

Charging and discharging of the resonant capacitor (the capacitor forming part of the resonant circuit with the inductor coils) and/or any included filter capacitor (discussed above) leads to internal heat generation within the capacitor. In typical inductive heating devices, this heat is wasted, and furthermore causes problems as it must be dissipated to avoid overheating, e.g. with a heat sink or other cooling means. By arranging the resonant capacitor and/or any included filter capacitors such that they are thermally coupled with the water receiving space, this heat may instead be usefully captured and utilized for contributing to water heating. The thermal coupling with the water also solves the problem of heat dissipation, providing integrated heat sinking via the water.

Different options are possible for thermally coupling the resonant capacitor and/or any included filter capacitors with the water.

In one set of embodiments, the resonant capacitor and/or any included filter capacitors may be contained within said insulative outer casing, fluidly isolated from the water receiving space but in thermal communication with the water receiving space. For example, the resonant capacitor and/or any included filter capacitors may be fluidly isolated from the water receiving space by a thermally conductive element. For example, the water receiving space may be contained within a water heating chamber, at least a portion of an outer wall of the chamber being thermally conductive, and the capacitor arranged thermally coupled to, i.e. in direct contact with, said at least portion of the chamber wall.

In accordance with one set of advantageous embodiments, the water receiving space may be enclosed by an electrically conductive housing, an interior surface of the housing arranged to contact water passing through the water receiving space between the inlet and the outlet, and the housing arranged to be inductively heated in use by the at least one inductor coil upon driving of current through the coil, and wherein the resonant capacitor and/or any included filter capacitors are arranged wrapped co-axially around the outside of electrically conductive housing, in thermal communication with, but electrical isolation from, the housing.

This arrangement has been found to lead to very efficient transfer of heat from the capacitor(s) to the water flowing through the water receiving space, since the total heat transfer area is large.

In examples, the resonant and/or filter capacitor(s) may be arranged rolled around the most external conductive tube, this tube forming the outer conductive housing.

In accordance with one or more example embodiments, the water receiving space may be configured such that water from the inlet firstly flows through the radial outer-most annular flow channel. This means that the temperature of the water that flows through this annular flow channel will be lowest, ranging from the inlet temperature and increasing to an intermediate temperature level, as it will continue to increase in subsequent water channels downstream. This means that a resonant capacitor and/or a filter capacitor rolled around this external conductive housing and in thermal communication with it will be exposed to a relatively low water temperature, efficiently removing the heat generated by the capacitor winding.

In a further set of embodiments, the resonant capacitor and/or any included filter capacitors may be contained within the water receiving space, fluidly and/or electrically insulated from the water, and in thermal communication with passing water. The resonant capacitor and/or filter capacitors may be fluidly sealed from the water in the water receiving space.

The resonant capacitor and/or any included filter capacitors may be contained within the water receiving space, electrically insulated from water flowing through the space, and in thermal communication with passing water.

This arrangement provides for most efficient heat transfer to the water from the capacitor. The arrangement enables a maximal amount of the heat generated by the capacitor to be utilized for heating the water.

It has not previously been considered to locate the capacitor in the water receiving space itself. Traditionally, it has been preferred to keep capacitors away from water, since leakage of water into the capacitor can cause electrical failure.

However, the applicant has found the surprising result that when located in the water receiving space, and suitably fluidly insulated to avoid fluid ingress, the capacitor can contribute up to 10% additional heat to the water compared to inductive heating alone. This significantly increases efficiency of the water heater. This significant efficiency benefit outweighs any costs associated with the additional structural requirements of fluid sealing/insulating of the capacitor.

According to one or more examples, a body of the resonant capacitor may define an annular shape with a central bore, and the capacitor arranged in the water receiving space such that the bore defines a water flow channel arranged for receiving water flowing between the inlet and the outlet.

This provides a highly space efficient arrangement. The flow channel provides for efficient heat transfer from the capacitor to the water (through the side walls of the bore), while also allowing free flow of water.

There may be further provided an array of radial heat dissipation fins within the capacitor bore, thermally coupled to the capacitor, for coupling heat to water passing through the bore.

The fins may extend radially inward from an inner wall of the bore toward the centre of the bore, with free flow paths defined between (tangentially) adjacent fins. The fins increase the total heat transfer surface between the capacitor and the water, thus increasing heat transfer efficiency.

The water flow channel defined by (the bore of) the capacitor may be fluidly connected to the inlet of the water heating unit.

Where the water receiving space includes said arrangement of delineated annular flow channels, the water flow channel of the capacitor may fluidly connect said inlet to the annular arrangement of flow channels.

Examples in accordance with a further aspect of the invention provide a water heating system comprising: a plurality of water outlets for providing outflow of water; and a respective point-of-use water heater in accordance with any embodiment or example described above or below or in accordance with any claim of this application, the water heater installed in-line with each of said water outlets for supplying each outlet with heated water.

Examples in accordance with a further aspect of the invention provide a water heating system comprising:

one or more water outlets for providing outflow of water;

a respective point-of-use water heater in accordance with any example or embodiment outlined above or described below, or in accordance with any claim of this application installed in-line with each of said water outlets for supplying each outlet with heated water; and

a remote or central generator arrangement, arranged in electrical communication with each of the respective point-of-use water heaters, and configured to provide a power supply signal to each of the heaters for electrically powering at least the driving of the at least one inductor coil of each heater.

The remote generator arrangement provides a single central generator arranged for supplying all of the one or more point of use heaters of the system.

The generator arrangement is preferably connected to each point of use heater by one or more cables.

In accordance with embodiments of this aspect of the invention, it is proposed to provide a central induction generator in electrical connection to each of the point of use water heaters for electrically supplying each heater. Preferably the generator is provided placed remotely to any point of use and in electric connection to each of the point of use water heaters. The central or remote generator performs at least a portion of the electrical conversion or transformation processes used in generating an alternating drive signal for driving the at least one inductor coil of each heater. This provides benefits since for example a separate high power mains connection does not need to be provided to each point of use. This provides safety benefits. It also enables in accordance with certain embodiments intelligent control of power provision to avoid over-draw of power by multiple heaters at once. The central generator may instead regulate power provision to each heater for example.

The remote generator arrangement is physically separated, i.e. spaced, from each of the water heaters. It may be positioned in a different room from each of the heaters or at least one or more of the heaters for example. It may be positioned at a greater distance from each of the heaters than the respective water outlet for each heater for example. It may be for example at a distance of at least 2 m from each water heater, for example at least 3 m, for example at least 5 m. In some cases, it may be at least 10 m away. These represent examples only and are in no way limiting of the general inventive concept.

In a preferred set of embodiments, each point of use heater comprises an outer housing or casing, and all components of the heater are contained within this housing or casing. However, in other possible embodiments, one or more components of each heater might be located just outside of the heater housing or casing (which contains at least the water receiving space), for instance physically coupled to the heater housing for instance by a mounting structure or frame. However, all components for each heater are located at the local point of use location comprising the water outlet for the respective heater.

In some examples, each respective water heater may be positioned at distance from the respective water outlet of no greater than between 1-2 metres, for example no greater than 1 metre, for example no greater than 0.5 metres. This limits water heat loss to the environment during travel of the water between the point of use heater and the water outlet. However, these distances represent examples only and are in no way limiting of the general inventive concept.

The power provided to the at least one inductor coil of each heater of the system may pass through a set of electrical components comprised by the system configured to convert incoming electrical power, e.g. mains supply power, and/or battery supply power, into an alternating drive signal having a frequency suitable for driving the at least one coil, for instance at a resonance frequency of a resonant circuit of which the coil is a part. By way of example, these may include an AC-DC rectifier, a bank of DC smoother capacitors and a DC-AC inverter, for example formed by a set of transistors or IGBTs arranged in for instance H-Bridge configuration, for converting the rectified DC power into the desired high frequency AC drive signal. Some of these components may be located at the central generator of the system, and hence shared by all of the point of use heaters of the system. One or more of these may be non-shared and located locally at each point of use heater. There are different options for how the components are distributed between the central generator and the one or more point of use heaters.

In some examples, the central generator may comprise an AC-DC conversion means for converting an input AC supply into a rectified DC signal, and a DC-AC conversion means configured to output, based on said rectified DC signal, an AC drive signal for driving the at least one inductor coil of the resonant circuit. The output AC drive signal may preferably have a frequency matching a resonance frequency of the resonant coil circuit of each heater.

In this case, each heater may be configured for receiving an AC drive signal and providing this signal to the one or more coils or to the resonant circuit, and each heater preferably does not include either an AC-DC conversion means or a DC-AC conversion means between a power input connector and the resonant circuit of the heater.

In accordance with one or more embodiments, each respective point of use water heater may be configured for receiving a DC power input signal, and wherein the remote generator arrangement is configured to supply this DC power input signal to each heater.

The DC power input signal is output from the remote generator and carried to each heater via a respective connecting cable for example.

The remote generator may be arranged to receive an AC power input. The generator arrangement may comprise AC to DC conversion means configured to convert said AC power input into an output DC power supply signal for provision to each of the respective water heaters. The AC power input may be from any suitable source, including for example a mains AC supply. The generator arrangement may comprise a mains input connection in particular examples.

The remote generator may further comprise one or more smoother capacitors electrically downstream from the AC-DC conversion means. This may comprise a bank of smoother capacitors.

In accordance with an advantageous set of embodiments, the generator arrangement may comprise a primary power input for receiving input power from outside the generator, and further comprising one or more batteries; and

the generator arrangement comprising control means configured for selectively implementing
a charging mode in which the battery is charged via power received through the primary power input, said primary power input being used for generating each of said power supply signal(s) for provision to each of the respective heaters; and
a battery draw mode in which stored power in the battery is used as a secondary power input for use in generating each of said respective power supply signals, either alone or in addition to the primary power input.

The control means may in some examples be configured to implement the battery draw mode to supplement the primary power supply during periods of high power draw, for instance when multiple point of use heaters are drawing power simultaneously.

For example, the control means may monitor the total power draw from the generator arrangement, and responsive to detecting that the power draw exceeds a pre-defined threshold level, or for example exceeds the primary power input, the control means may trigger the battery draw mode. It may for example switch from the charging mode to the battery draw mode. Thus when the instantaneous electrical power available is limited and below the needs of the heater or heaters in operation, the electrical battery may be used to provide part or all of the required electrical power.

This advantageously allows for multiple point of use heaters to be operated simultaneously within a system, and at maximum power, despite potential limits on the maximum mains current supply into the system. Known systems for example are severely restricted in the number of point of use heaters which can be operated simultaneously, and/or the maximum power output of each heater, since the total power consumption is constrained by the maximum current supply into the dwelling. By using a supplementary battery which is charged during periods of low power draw, the power supply to the heaters can be boosted during periods of high demand.

In accordance with advantageous examples, an electrical filter means may be provided between the one or more batteries and the remaining components of the generator, for filtering high frequencies. The use of batteries, together with filtering capacitors to filter out high frequencies provides a very safe and efficient configuration for input to a downstream inverter for example.

In accordance with preferred embodiments, the water heating system may comprise a control means configured for controlling the AC frequency of the AC drive signal supplied to the resonant circuit of each water heater for driving the at least one inductor coil of each heater to oscillate. The AC drive signal is output by a DC-AC conversion means which may be located centrally at the remote generator, or a separate DC-AC conversion means may be included as part of each heater. In either case, the control means may control generation of one or more guide signals indicative of a target AC frequency output of the DC-AC converter, wherein the DC-AC conversion means is adapted to generate an output AC drive signal in accordance with the guide signal indicated frequency.

This control means may be centrally located at the remote generator arrangement, and wherein the one or more guide signals are communicated to each of the one or more heaters via a wired or wireless connection.

Alternatively, at least part of the control means may be distributed among the one or more heaters, for example such that the one or more guide signals for a given respective heater are generated locally at said heater. This arrangement avoids potential issues with guide signal transmission from the centralised generator to the DC-AC conversion means for each heater, when the latter is located remotely at the point of use. It is known that these systems are sensitive to the distance between the guide signal generator (for example one or more gate driver elements) to the receiving DC-AC conversion components (for example transistors or IGBTs). This may be overcome by placing the guide signal generation elements (e.g. gate driver) locally as part of each respective point of use heater.

In accordance with preferred embodiments, the system may include electronic control means adapted to monitor and react to one or more inputs of the system (e.g. user inputs or sensor inputs) as part of a closed feedback loop. For instance a user may set a desired water temperature for one or more of the heaters of the system. The control means may read this input, read from a temperature sensor the actual output temperature and react to divergences between the two parameters in a given heater by adjusting a heating power level of the respective heater for example. The control means may be centralised or distributed among the one or more water heaters in different examples.

The control means may also read one or more user inputs and/or system parameters such as electrical power deposition, and water temperature. Electrical power deposition on each point of use heater unit may be monitored and controlled.

A further aspect of the invention provides the use of an inductor coil placed interior of a water receiving space of a water heater, for making contact with water flowing through the space, to inductively heat one or more conductive bodies located in the water receiving space for heating the water.

Examples in accordance with a further aspect of the invention provide a point of use induction water heating method for heating water in-line with a water supply pipe, the method comprising:

receiving water into a water receiving space, the water receiving space arranged between an inlet and an outlet;

driving at least one inductor coil contained in the water receiving space and arranged for making contact with (and/or to be submerged by) water flowing in use between the inlet and the outlet with a current to thereby magnetically induce electrical currents in at least one conductive body contained in the water receiving space for heating the conductive body, and to thereby heat water flowing in use between the inlet and outlet.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 shows an isometric view of an example water heater according to one or more embodiments;

FIG. 2 shows a cross-section through the example water heater of FIG. 1;

FIG. 3 shows an exterior view of the example water heater of FIG. 1;

FIGS. 4-5 illustrate an example inductor coil arrangement for use in a water heater according to one or more embodiments;

FIG. 6 shows an exploded view of the example water heater of FIG. 1;

FIGS. 7-9 illustrate the magnetic field strength distribution around an example inductor coil as implemented in one or more embodiments;

FIG. 10 illustrates water flow velocity through a water flow channel of an example water heater according to one or more embodiments;

FIG. 11 illustrates advantageous flow channel widths for a heater according to one or more embodiments;

FIGS. 12 and 13 illustrate a further example water heater according to one or more embodiments, the heater incorporating a resonant capacitor;

FIGS. 14-16 show views of an example capacitor for inclusion within an example water heater according to one or more embodiments;

FIGS. 17-18 illustrate electrical connection of an example inductor coil arrangement to a capacitor for use in a water heater according to one or more embodiments;

FIGS. 19 and 20 illustrate a further example water heater according to one or more embodiments, the heater incorporating a DC-AC conversion means;

FIG. 21 shows a further view of electrical components of the heater embodiment of FIGS. 19 and 20;

FIG. 22 shows the DC-AC conversion means of the heater of FIGS. 19-20;

FIG. 23 shows a further view of electrical components of the heater embodiment of FIGS. 19 and 20; and

FIG. 24 schematically illustrates the electrical arrangement of an example water heating system in accordance with one or more embodiments.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides a point of use induction water heater having a water receiving space arranged between an inlet and outlet, and at least one inductor coil disposed in the water receiving space, arranged to contact water flowing between the inlet and outlet. At least one conductive body is also contained in the water receiving space, and arranged to be inductively heated by the inductor coil upon driving of the coil with a current.

As noted above, typical heaters have the induction coil external to the water heating space. By locating the inductor coil inside the fluid receiving space, two main benefits are achieved. First, Joule heat generated by the coil can be usefully used for heating water, as it is directly transferred to water passing over the coil as it journeys from the inlet to the outlet. Second, there is enabled the possibility, according to certain embodiments, of providing coils in close proximity to more than one target conductor, or even interleaving coils and conductor bodies, which enables greatly enhanced heating density and output.

Furthermore, typical heaters with the inductor coil external to the water receiving space require auxiliary means for cooling the induction coil, or dissipating the heat generated, e.g. with a heat sink. By locating the coil in fluid contact with flowing water, the water itself performs the heat sink function.

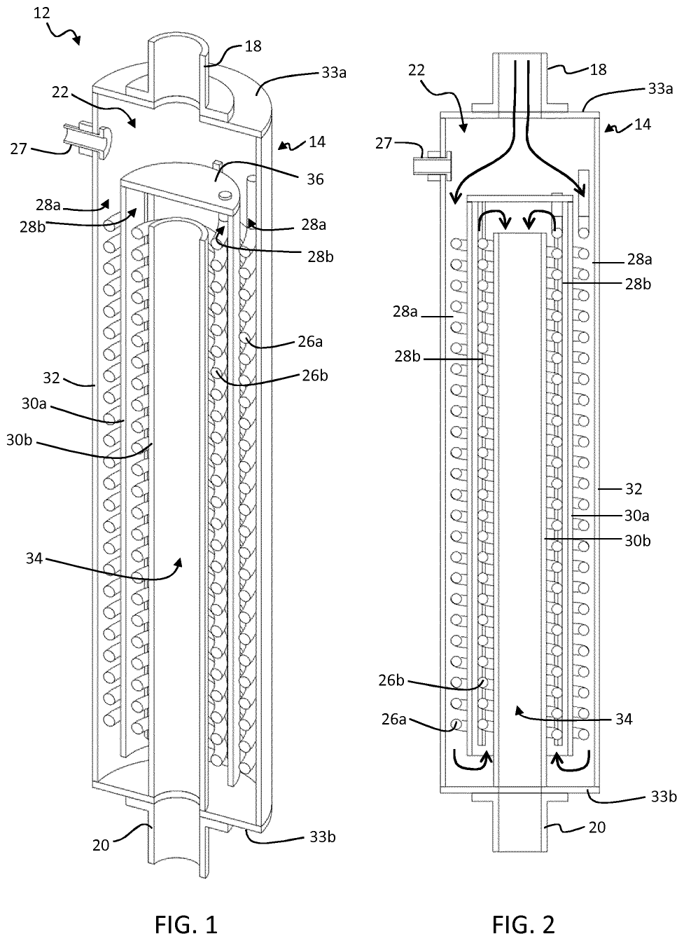

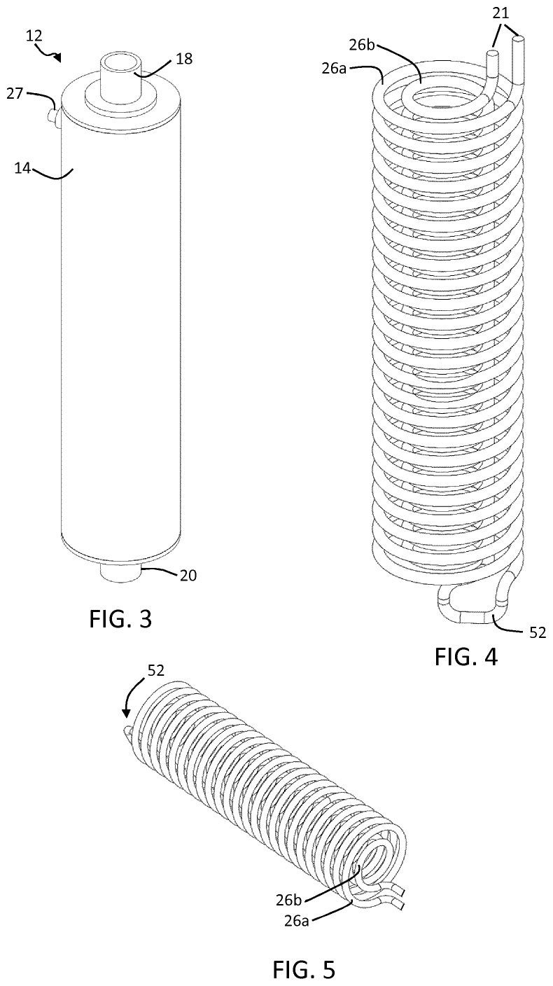

FIGS. 1-3 illustrate a first example point of use induction heater in accordance with one or more embodiments of the present invention. FIG. 1 shows a cut away isometric view illustrating an interior of the unit. FIG. 2 shows a cross-sectional view along an axial plane of the heater. FIG. 3 shows an isometric view of an exterior of the unit.

The heater 12 comprises an inlet 18 and an outlet 20 with a water receiving space 22 defined between the inlet and outlet. In the example of FIG. 1, the water receiving space 22 is formed by an inner cavity or chamber defined within an outer housing 14, the outer housing being formed by an electrically conductive tubular body 32, the tubular body being covered at each axial end by respective cover members 33a, 33b. The inlet 18 and outlet 20 fluidly connect to respective axial ends of the tubular housing, each extending through a respective one of the cover members.

In some examples there may further be provided an electrically insulative outer casing which wraps around the (electrically conductive) housing 14 enclosing the water receiving space. This may include for instance a plastic insulating layer wrapping around the housing 14. This may further be covered by a metal outer shell. The metal outer shell is preferably grounded when installed, for safety.

Mounted within the water receiving space 22 are two inductor coils 26a, 26b, having differing outer (helical) diameters and co-axially arranged with respect to one another. The inductor coils are arranged in the water receiving space so as to make contact with water flowing in use between the inlet 18 and the outlet 20. As shown, the windings (i.e. turns) of each coil are axially spaced from one another, forming water flow spaces between neighbouring windings.

Although in the particular example of FIG. 1, there are two inductor coils, this is not essential, and the heater may in other examples comprise any other number of conductor coils, greater or fewer. The coils are co-axially arranged in the example of FIG. 1, providing a particularly space efficient arrangement. However, this arrangement is not essential, and in other examples, different arrangements may be provided.

Also mounted in the water receiving space are two co-axially arranged electrically conductive tubes 30a, 30b. These, in combination with the tubular body 32 of the housing 14, define within the water receiving space an arrangement of outer annular flow channels 28a, 28b, co-axially arranged with respect to one another, surrounding an inner axial flow channel 34. In each of the annular flow channels is disposed a separate one of the inductor coils 26a, 26b. In this way, the inductor coils are arranged co-axially inset between the conductor tubes, and arranged in respective annular flow channels formed by the conductor tubes.

Although only two inner submerged conductor tubes 30a, 30b are shown in the example of FIG. 1, in further examples any number of conductor tubes, one or more, may be provided. For example, more conductor tubes may be added, each additional conductor tube providing an additional annular flow channel defined with respect to a neighbouring tube.

A first (and radially outer-most) annular flow channel 28a is formed by a radial spacing between an inner wall of the tubular body 32 of the housing 14, and an outer wall of the first conductor tube 30a. A second annular flow channel is formed by a radial spacing between an inner wall of the first conductor tube 30a and an outer wall of the second conductor tube 30b. The axial inner channel 34 is formed by a tubular interior space of the second conductor tube 30b.

The conductor tubes 30a, 30b, and in this example the tubular body 32 of the outer housing 14, are each tubular bodies of an electrically conductive material. They act as targets for the inductor coils 26a, 26b and are arranged to become inductively heated by the inductor coils upon driving of the inductor coils with alternating current. In particular, they are arranged such that driving of the inductor coils induces electric currents (eddy currents) in the conductor tubes. These currents act to heat the conductor tubes, thereby heating water flowing through the various flow channels 28a, 28b, 34.

As illustrated in FIG. 1 and FIG. 2, the annular flow channels 28a, 28b and the inner axial flow channel 34 are connected in fluid series with one another, defining a single continuous flow path between the inlet and outlet via the plurality of connected channels. More particularly, the channels are connected end-to-end to, thereby defining a labyrinthine flow path between the inlet and outlet.

To facilitate this labyrinthine flow arrangement, and end cap 36 is provided closing one end of the first tubular conductor body 30a. In particular, the end cap closes an upper end, adjacent the inlet 18. The lower end of the first inner tubular conductor 30a is open, and arranged to stop short of a base of the water receiving space 22, thereby defining a fluid connection path between a radial outer-most 28a of the annular flow channels and a next radially adjacent annular flow channel 28b.

The second 30b of the inner conductor tubes (co-axially inset within the first 30a) is directly connected at a lower end to the outlet 20. This end is thus effectively closed or sealed to the immediate water receiving space around it. The upper end of the second inner conductor tube is open, and extends to a point axially short of the capped upper end 36 of the first conductor tube 30a, thereby forming a clearance space between the two and defining a fluid connection path between the second annular flow channel 30b and the inner axial flow channel 34.

A flow route of water through the water receiving space 22 during operation is illustrated in FIG. 2. In use, water is received into the water receiving space 22 via the inlet 18. The water is directed around the outside of the first conductor tube 30a (being baffled by the end cap 36) and into the (radially outer-most) first annular 28a flow channel. The water flows through the first annular flow channel, making contact with, and fully submerging, the first inductor coil 26a. The water then flows to the second annular flow channel 28b via the connected lower ends of the two channels, and makes contact with and submerges the second inductor coil 26b as it flows through the second annular flow channel. The water then flows to the inner axial flow channel 34 via the connected upper ends of the two channels 28b, 34, and flows along this axial channel directly to the outlet 20 of the water receiving space, the axial channel lower end being directly connected to the outlet.

Hence the water passes along a labyrinthine flow path through the water receiving space, making contact both with the walls of conductor tubes and the inductor coils as it passes. Hence heat is transferred to the water from both of these elements.

FIGS. 4-5 show the inductor coils 26a, 26b in more detail. FIG. 4 shows a perspective view of the inductor coils. FIG. 5 shows a second perspective view.

The two inductor coils 26a, 26b are each formed by a conductive wire or winding which winds helically between lower and upper axial ends. This may be formed of an electrically conductive core, e.g. a wire or other conducting strand. The coil should be rigid enough to retain its shape.

The two inductor coils 26a, 26b are connected in electrical series via a bridge section 52 at a lower end of the coils. This bridge section is shaped so as (in the assembled device) to loop down and underneath a lower circumferential rim of the first inner conductor tube 30a positioned between the two inductor coils.

Although not shown in FIG. 1, 2 or 4, in the assembled heater unit 12, the upper ends 21 of the two inductor coils 26a, 26b are connected to upper connecting parts which provide for electrical connection of the coils to outside of the heater unit. These connecting parts are arranged to extend to outward of the water receiving space through the wall of the outer housing 14 via an opening 27. This allows for electrical connection to the coils.

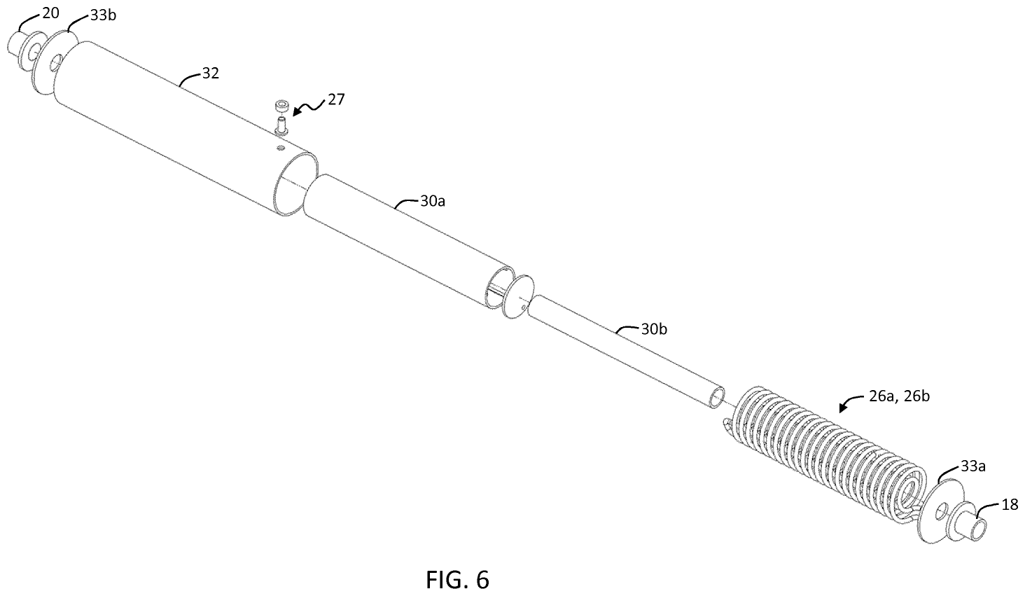

FIG. 6 shows an exploded view of the example water heater of FIGS. 1-5 above. It can be seen how the simple construction of coaxially inset tubes and coils provides for very straightforward assembly. The various annular components can be installed or mounted one by one, each part fitting co-operatively in annular fashion within or around the other components. Despite the simple construction, a relatively complex flow path arrangement is nonetheless created.

In use, the coils are each driven with an alternating current of the same frequency. The coils are connected in series in this example, thereby facilitating concurrent driving of the two coils in phase with one another.

Upon driving the inductor coils 26a, 26b with the oscillating current, an alternating magnetic field is created about each coil. The field runs cyclically around each part of the coil line, and the fields across the whole coil superpose to create a net axially directed field running axially through the centre of the coil spiral. This field is received by the electrically conducting tube(s) 30a, 30b, 32 disposed radially spaced from the coil. The alternating field in turn induces in each of the conductor tubes (by Faraday's law) alternating currents (eddy currents) circulating about the around directionality of the field. These eddy currents cause heating (joule heating) in each conductor tube, which heat is then, during operation, transferred to water passing through the various flow channels 28a, 28b, 34 which the tubes define between them.

Disposing the conductor tubes 30a, 30b coaxially inset between the inductor coils 26a, 26b makes use of a proximity effect to maximise the strength of induced currents in the conductor tubes. In particular, for each given coil, the regions of minimum field strength are those directly between the different loops of the coil line. This is because the current in each loop runs in the same direction, and hence, the magnetic field created around each loop line circulates in the same direction.

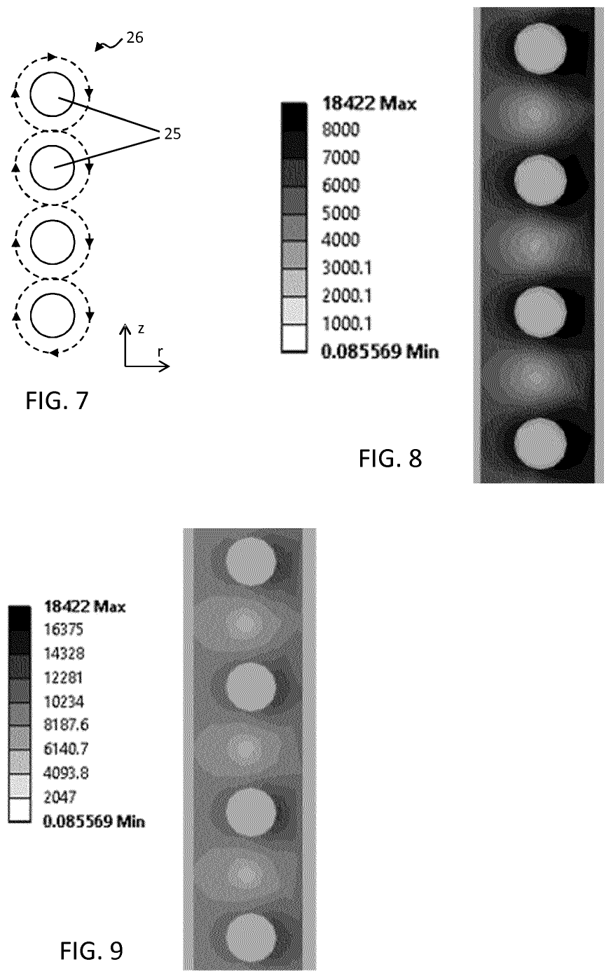

This is shown schematically in FIG. 7, which illustrates a cross section through a set of four loop turns 25 of a particular coil 26. Radial (r) and axial (z) directions are illustrated. The circulating magnetic fields are illustrated with dotted lines. As can be seen, in the region between each neighbouring pair of turns 25, the fields are directed in opposite directions, and hence destructively superpose and substantially cancel out. The field strength in this region is minimal. By contrast, in the region just radially offset from the coil, the fields are all aligned in the same direction and hence constructively interfere to generate a region of maximal magnetic field (aligned in an axial direction).

The simulated field strength (intensity) distribution for the example portion of the inductor coil shown in FIG. 7 is illustrated in FIG. 8. FIG. 9 shows the same field strength distribution chart with slightly different shade gradations, for clarity. The magnetic field strength for each shade of grey (in units of Amperes per metre) is indicated in the respective accompanying key for each chart.

It can be seen that the highest field strength is in the region immediately radially adjacent the coils (to the left and right in the figure), with minimal field strength being in the region between coils.

In embodiments of the present invention, the conductor tubes 30a, 30b and preferably also the tubular body 32 of the housing 14 are placed in positions slightly radially offset from the inductor coils 26a, 26b, and hence in positions of maximal field strength. The field strength declines with increasing radial distance from the coil. Hence by placing each tube immediately radially adjacent a respective inductor coil, each tube is exposed to a field of maximal field strength and induced heating eddy currents in each tube have maximal strength. Hence inductive heating is maximised.

It is possible according to embodiments of the present invention to place multiple interior conductor tubes 30a, 30b each immediately radially adjacent a respective inductor coil 26a, 26b because the inductor coils are disposed inside the water receiving space 22. This therefore allows for coaxial stacking of inductor coils immediately adjacent coaxially arranged conductor tubes within the heating space—something not possible when all inductor coils are confined outside the chamber, and hence disposed remote from the interior conductor tubes.

Furthermore, the arrangement of coaxially inset inductor coils 26a, 26b and conductor tubes 30a, 30b, 32 of embodiments of the present invention means that for at least a subset of the conductor tubes, the tube is arranged sandwiched between a pair of respective inductor coils. Advantageously, the coaxially arranged coils 26a, 26b may be electrically supplied and/or configured or designed such that a current supplied through radially neighbouring coils runs in circumferentially opposite directions. In this way, the fields of the radially neighbouring coils constructively interfere within the radial spacing between the coils. This then leads to a double proximity effect for the conductor tube, as the conductor tube is placed in a region of maximal field strength of two inductor coils, where the two fields combine constructively.

As discussed above, the conductor tubes 30a, 30b, in combination with the outer housing 14 define within the water receiving space 22 an arrangement of annular flow channels through which water is forced to flow en route between the inlet and outlet. This narrow labyrinthine flow path increases flow velocity of water past the heating elements.

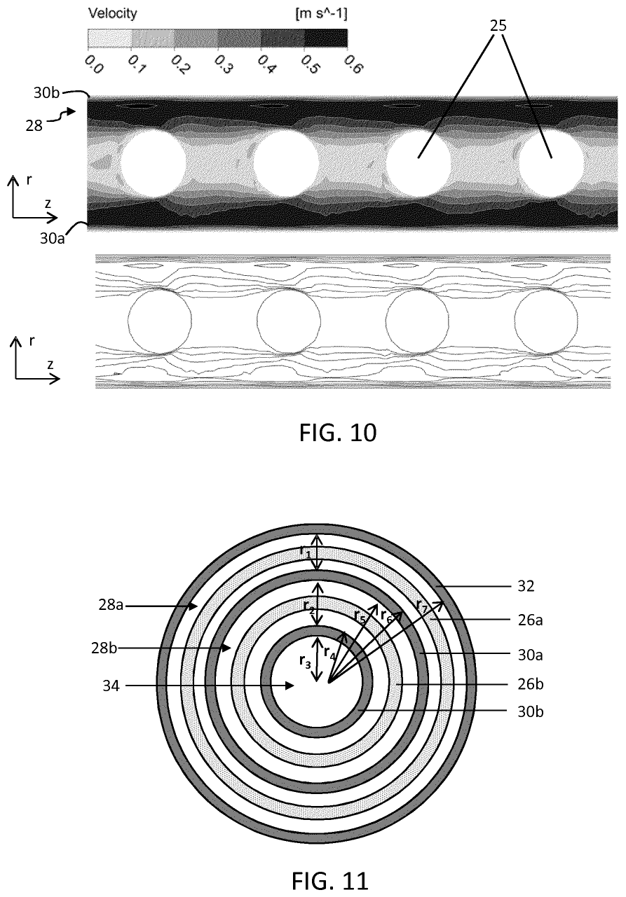

This is advantageous for purposes of heat transfer to the water, as heat transfer rate into a fluid increases as the velocity of the fluid increases. By way of illustration, FIG. 10 shows a simulated velocity flow diagram for water flowing through a section of one annular flow channel 28, the channel having an inductor coil 26 disposed centrally therein. The figure shows a cross-section through the example flow channel, with the cross-sections through a set of four loops 25 of the coil illustrated.

As shown, the flow velocity through the flow channel 28 is greatest in the outer regions of the flow channel, radially adjacent the inductor coil 26, and lowest in the regions between respective inductor coil loops 25. This is beneficial, since this outer region of the flow channel is disposed between both the inductor coil 26 and the conductor tube 30, 32 bounding the channel. Hence water flowing through this part of the channel makes contact with both the conductor tube wall and inductor coil outer surface. Hence the fastest flow region (and hence that for which heat absorption rate into water is greatest) is the region in which water makes contact with both heat source surfaces at the same time.

In advantageous examples, annular cross-sections of the annular flow channels 28 are adapted to provide uniform flow velocity through each channel, i.e. the cross-sections are configured such that there is equal flow velocity through each channel. This is advantageous to ensure balancing of water pressure drop through the different channels, and also to ensure equalising of heat absorption rate in each channel (since heat transfer rate is dependent on water flow speed). Preferably, the flow velocity through the annular flow channels and also the axial flow channel are all rendered the same. In this way, velocity is constant throughout the heater.

The flow velocity is primarily a function of the cross-sectional flow area through a given channel. The cross-sectional flow area means the cross-sectional area through each channel through which water flows in use. To provide substantially equal flow velocity through each flow channel 28, the flow channels may be provided having substantially equal cross-sectional flow area.

The cross-sectional flow area may in examples be approximated as the total cross-sectional area of a channel minus the cross-sectional area occupied by the respective inductor coil 26 in the given flow channel (since water cannot flow through this region).

Since the circumferences of the flow channels 28, 34 declines for channels more radially inward, maintaining constant cross-sectional flow area requires that annular radial widths of channels more radially inward are larger than those more radially outward.

This is illustrated schematically in FIG. 11 which shows a cross-section through the heater arrangement of FIGS. 1 and 2 above. The radially outer annular flow channel 28a having larger circumference is provided having a smaller radial width than the radially more inward annular flow channel 28b, i.e. r₂>r₁.

By way of simple example, where each channel is approximately circular in cross-section, for equal cross-sectional area through each channel, the following should hold: r₃²=r₅²−r₄²=r₇²−r₆².

To then ensure equal cross-sectional flow area, the area occupied in each channel by the respective inductor coil 26 should also be taken into account, i.e. subtracted from the area of each channel, i.e. r₃²=(r₅²−r₄²)−(coil 26b area)=(r₇²−r₆²)−(coil 26a area).

By way of one advantageous example, the flow channel cross-sections may be adapted to provide a flow velocity through each channel of around 1.0-1.5 m/s. This provides an ideal balance between pressure drop across each channel and also efficient heat transfer.

By way of one example, each flow channel 28, 34 may be provided with a cross-sectional area of between 1.2 cm² and 2.2 cm² (0.00012-0.00022 in²).

According to an advantageous set of embodiments, the dimensions of the coil and the electrically conductive tubes are adapted such that the heat transfer rate (power deposition) per unit area to the water from the conductive tubes substantially matches the heat transfer rate per unit area from the inductor coils. This has the effect that the surface temperature of each coil across all points is substantially equal to the surface temperature of each of the conductive tubes at every point. This equalises the heat transfer into the water by each of the coils and conductive tubes and avoids occurrence of local hot-spots which might lead to local water boiling.

This may be achieved by providing the inductor coils 26 and conductive tubes 30a, 30b, 32 such that the ratio of the total water-contacting surface area of the set of inductor coils to the total water-contacting surface area of the set of conductive tubes 30a, 30b, 32 is equal to the ratio of the total power deposition (to the water) of the set of inductive coils to the total power deposition of the set of conductive tubes. The total power deposition of the coils means the total heat transfer (to the water) per unit time of the set of inductive coils. The total power deposition of the inductive tubes means the total heat transfer (to the water) per unit time of the set of conductive tubes.

By way of example, simulations performed for one embodiment of the heater have found that the relative effective power deposition (to water) of the inductor coils 26a, 26b is larger than that of the conductive tubes 30a, 30b, 32, by approximately 20-30%.

Hence, according to one or more examples, the inductor coils 26a, 26b may be provided such that the set of coils together have a total water contacting surface area larger than a total water contacting surface area of the set of conductive tubes 30a, 30b, 32. In particular, in preferred examples, the set of coils together have a total water contacting surface area between 20-30% larger than a total water contacting surface area of the set of conductive tubes 30a, 30b, 32.

This means that for each unit of supplied power, that power is spread over a substantially equal water-contacting area for the coils and for the tubes. Hence the higher power deposition of the coils is balanced by a larger surface area across which that power is spread.

Maintaining the power deposition ratio and the total surface area ratio aligned ensures substantially equal surface temperature on the coil and conductive tube heat transfer surfaces. This substantially avoids the risk of water boiling due to surface temperature hot-spots caused by a large power deposition in a relatively small area.

According to advantageous embodiments, the heating unit 12 may further comprise a capacitor coupled to the inductor coil(s) 26 to form with the coil(s) a resonant circuit having a resonance frequency. For ease of reference, such a capacitor, forming part of a resonant circuit in combination with the at least one coil, may be referred to in this disclosure as a resonant capacitor.

The coupled coils 26a, 26b and capacitor together form a resonant LC circuit.

As discussed above, coupling an inductor coil with a capacitor to form a resonance circuit significantly increases electrical efficiency of the device. In use, energy can oscillate or resonate back and forth between the storage capacities of the coil and the resonant capacitor. This means that energy input into the inductor coil (to drive generation of a field) is not lost upon its discharge from the coil. Instead the energy is transferred to the resonant capacitor before being discharged back again to the inductor coil. Only ‘top-up’ energy need be supplied to the circuit, to compensate the energy actively transferred into the conductive bodies by magnetic induction, and resistive losses in the wires.

The resonance frequency is a function of both the capacitance, C, of the capacitor and the inductance, L, of the inductor. The angular resonance frequency, coo, in a simple circuit may for instance be determined from the standard equation ω₀=1/\sqrt{LC}, where C is capacitance of the capacitor and L is inductance of the inductor coil.

Resonance of the circuit, and thus the energy conservation, is only achieved when the circuit is driven at its resonance frequency.

Hence, in accordance with one or more embodiments, the heating unit 12 may further comprise a local generator or controller adapted to drive the inductor coil at said resonance frequency, i.e. drive the coil with an alternating current having a frequency equal to said resonance frequency. Alternatively, the heater 12 may be arranged to receive from outside the heater an alternating drive signal suitable for driving the inductor coil at resonance.

Different arrangements are possible for the resonant capacitor.

In advantageous arrangements, the water heater may comprise an electrically insulative outer casing, the casing housing or encasing the water receiving space, and the resonant capacitor being contained also within the casing.

The resonant capacitor may be contained within the water receiving space itself, or may be outside of the water space but still within the insulative casing, for instance in an isolated cavity formed within the casing, separated from the water receiving space.

In either case, by locating the capacitor within the electrically insulated outer casing, all of the reactive power of the heating device is confined within the outer housing or casing. The only power which need be supplied from outside the heating unit outer housing are those required to ‘top-up’ the resonant circuit with power lost through actual heating of the water and those required to initially charge the resonant circuit (i.e. ‘active power’).

In known arrangements, the capacitor is typically positioned outside or remote from the heater 12, (for example close to a generator unit). However, this necessitates that the connecting cable transport not only the active electrical loads (associated with the energy transferred into the water), but also the reactive electrical loads, passing between the capacitor and the inductor. This incurs associated safety and cost issues.

Enclosing all reactive power within the heater unit casing enables safer power transfer from the mains power source to the point of use, as only active power need be transferred.

In advantageous examples, the capacitor is arranged to be in thermal communication with the water receiving space 22 for transferring heat to water flowing through said space between the inlet and outlet.

Charging and discharging of the capacitor leads to internal heat generation within the capacitor. In typical inductive heating devices, this heat is wasted, and furthermore causes problems as it must be dissipated to avoid overheating, e.g. with a heat sink or other cooling means. By arranging the capacitor such that it is thermally coupled with the water receiving space, this heat may instead be usefully captured and utilized for contributing to water heating. The thermal coupling with the water also solves the problem of heat dissipation, providing integrated heat sinking via the water.

In one set of examples, the capacitor may be arranged inside the water receiving space, electrically insulated from water flowing through the space, and in thermal communication with passing water.

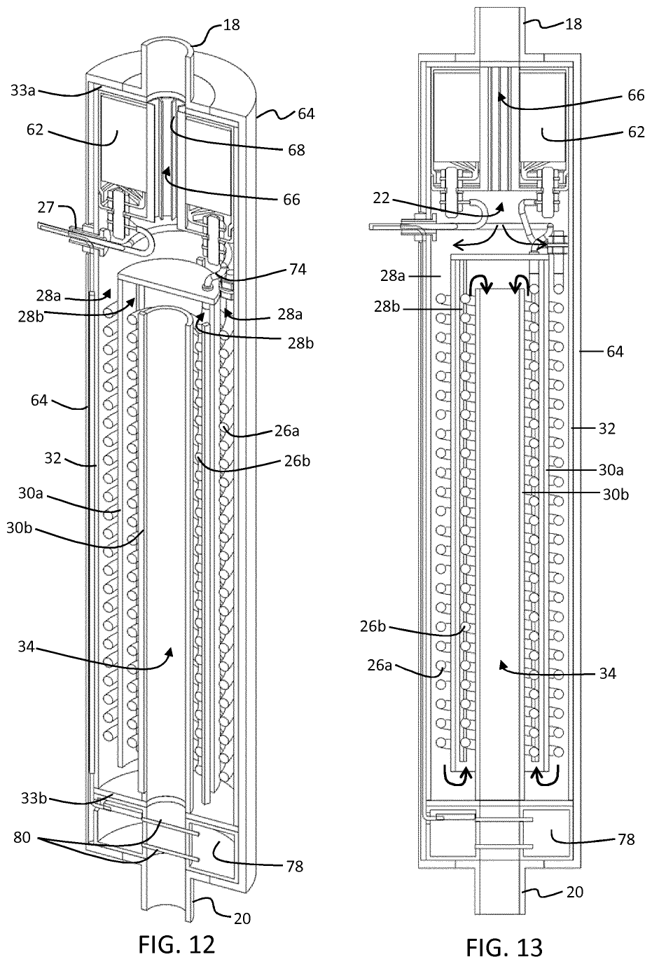

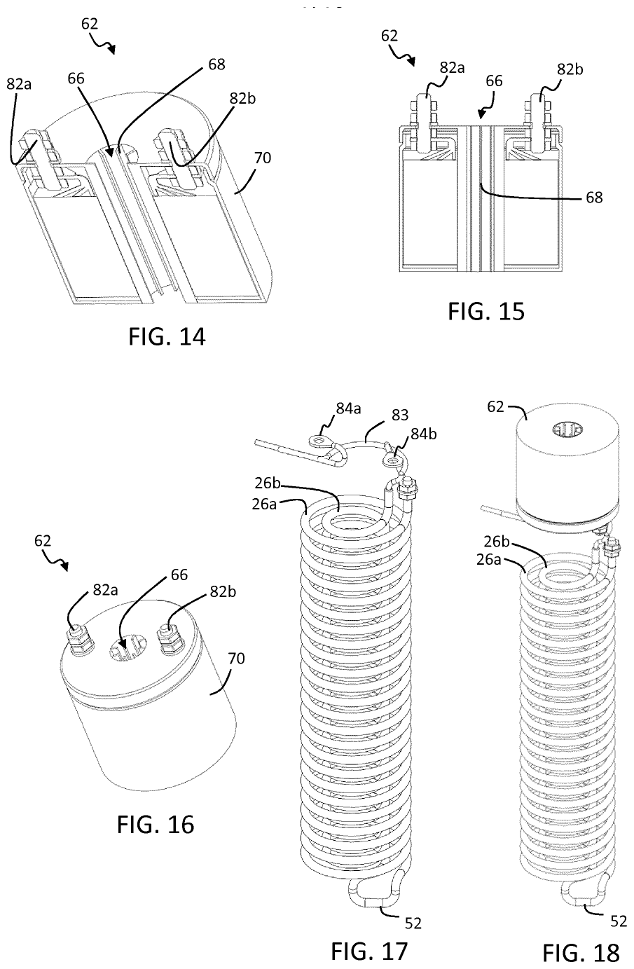

One example water heater 12 according to such an embodiment is illustrated in FIG. 12 and FIG. 13. FIGS. 14-16 show the example capacitor employed in this example. FIGS. 17 and 18 show the inductor coils 26a, 26b and the electrical connection arrangement between the coils and the capacitor.

The example water heater 12 is substantially the same as that described above with reference to FIGS. 1 and 2, apart from the further inclusion in the water receiving space 22 of a capacitor 62, and the additional electrical connections provided between the inductor coils 26a, 26b and this capacitor. There is also provided an electrically insulative outer casing 64 which wraps around the (electrically conductive) housing 14 enclosing the water receiving space.

The outer housing 14 has been extended slightly at the end adjacent the inlet 18, to provide space to fit the capacitor. The arrangement of the conductor tubes 30a, 30b, and inductor coils 26a, 26b and also the flow channel arrangement defined by the conductor tubes within the water receiving space 22 are all the same as in the example of FIGS. 1 and 2. These will therefore not be discussed in detail again here. All details and options described above in relation to the example of FIGS. 1 and 2 may be applied also to the present embodiment.

The outer casing 64 provides an electrically insulative enclosure to ensure safe electrical isolation of all electrical parts inside. For example, the casing wall may include a plastic insulating layer wrapping around the housing 14 enclosing the water receiving space. This may further be covered by a metal outer shell. The metal outer shell is preferably grounded when installed, for safety.

The capacitor 62 is arranged in the water receiving space 22 immediately adjacent the inlet 18. The capacitor has an annular shape, extending annularly around a central bore 66 defined through the capacitor, this bore forming a water flow channel through which water received into the water receiving space may flow, making thermal contact with the capacitor as it passes. An array of radial heat dissipation fins is provided within the central bore 66 for improving thermal transfer between the capacitor and the passing water. These can be seen more clearly in FIG. 14 for instance. The fins may be formed of any thermally conductive material, such as metal.

The capacitor 62 is arranged with the water flow channel formed by the central bore 66 directly connected with the inlet 18 of the water receiving space 22. In this way, the capacitor receives and makes contact with the water when it first enters the water receiving space, and hence when it is at its coolest. This is preferred in this case, since heat transfer into a fluid is maximal when the temperature difference between the fluid and the heat source is greatest. In general, the heat generated by the capacitor will be lower than that generated by the coil 26 and the inductively heated tubes 30a, 30b. Hence, this less hot component should make contact with the water when it too is less hot, to optimise overall heat transfer into the water. The hotter coil 26 and tubes 30 will be able to transfer heat to the water even after it is warmed by the capacitor.

As the water flows in through the inlet 18 and through the capacitor 62 bore 66, heat is transferred from the capacitor to the water. Upon flowing out of the bore 66, the water follows the same fluid flow path as in the example of FIGS. 1 and 2. This flow route is schematically illustrated in FIG. 13. The route is described in detail above, with reference to FIG. 2.

The capacitor is encased in a water-tight sealing or casing to prevent ingress of water internally into the capacitor. The casing or sealing is also electrically insulative, i.e. including an electrically insulating material.

The capacitor 62 is shown in detail in FIGS. 14-16. FIGS. 14 and 15 show isometric and cross-sectional views respectively through a centre of the capacitor. FIG. 16 shows an exterior view of the capacitor.

The central bore 66 is visible more clearly in FIG. 14. The array of radial fins 68 is also shown. The fins each are coupled to an interior wall of the capacitor bore 66.

The water-tight casing 70 or sealing of the capacitor 62 can be seen more clearly in FIGS. 14 and 16. This forms a fluid tight and electrically insulative shell around the capacitor.

Protruding from an axial end of the capacitor 62 are two electrical connectors 82a, 82b for electrically coupling the capacitor to the inductor coils 26a, 26b and the power source.

Electrical connection between the inductor coils 26a, 26b and the capacitor 62 is illustrated in FIGS. 17 and 18. The inductor coils themselves and their arrangement relative to one another is the same as in the example of FIGS. 1-2 and 4. The only difference is in the arrangement of the electrical connecting parts. In the present embodiment, the coil 26b is coupled directly to the capacitor electrical connector 82b via a connection loop 84b. The capacitor electrical connector with opposite polarity 82a connects to the connection loop 84a which is then routed out of the heater through an opening 27. The inner induction coil 26a is routed out of the heater via an arcuate connecting arm 83 and through opening 27. In alternative examples, the inner induction coil and/or connection loop 84a may be routed to a further space within the heater for connection for instance to further electrical components in the heater, e.g. DC-AC conversion means.

In the particular example of FIGS. 12-13, the capacitor 62 is provided disposed within the water receiving space 22. This maximises heat transfer efficiency. However, this arrangement is not essential. In other examples, the capacitor may for example be disposed inside an electrically insulative outer housing and separated from the water receiving space. The capacitor may be thermally coupled with water flowing through the water receiving space 22. For example, in some arrangements for instance the water receiving space may be contained within a water heating chamber, at least a portion of an outer wall of the chamber being thermally conductive, and the capacitor arranged thermally coupled to, i.e. in direct contact with, said at least portion of the chamber wall. For instance the capacitor may wrap around the outside of this chamber wall.

By way of one example, a suitable capacitor may be provided having a capacitance of between 0.2-1.2 μF, preferably between 0.3-0.5 μF, even more preferably, 0.35-0.45 μF, for example 0.41 μF. Any suitable conductive material may be used for the capacitor conductor, such as copper. Any suitable dielectric may be used, for example Polyamide. Suitable layer thickness for the conductor may be for instance be in the order of 0.05 mm, for instance, 0.02-0.08 mm. Suitable layer thickness for the conductor may be for instance be in the order of 0.02 mm, for instance, 0.01-0.07 mm.

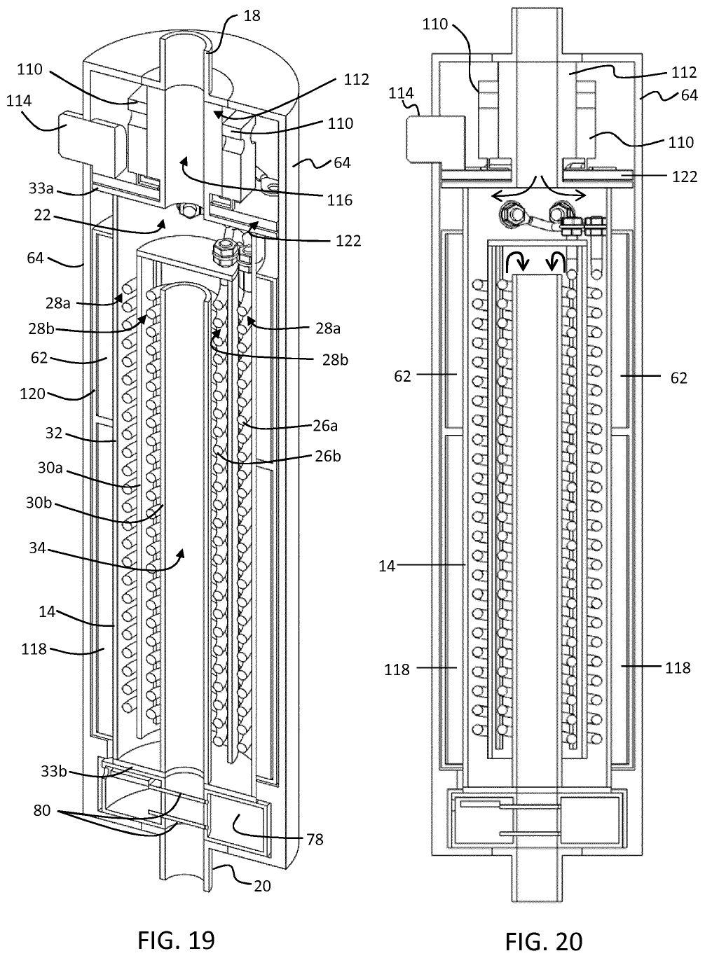

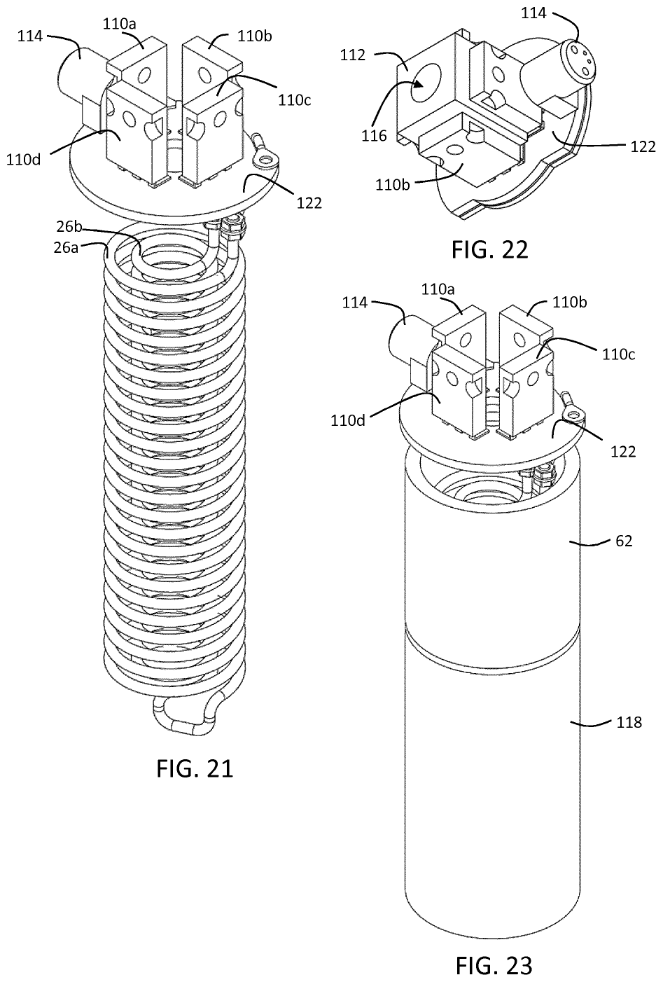

A further example water heater in accordance a further set of embodiments is shown in FIGS. 19-23. FIG. 19 and FIG. 20 show isometric part cut-away and sectional views respectively of the heater. FIGS. 21-23 shows further views illustrating the DC-AC conversion means, the inductor coils and the capacitors.

The example water heater 12 is substantially the same as that shown in FIG. 12 and FIG. 13 apart from the further inclusion in the heater of a DC-AC conversion means and a filter capacitor 118 connected between a power input connector 114 and the DC-AC conversion means, and also the rearrangement of the resonant capacitor 62 within the heater housing. These features will be further explained below.

In accordance with this set of embodiments, the water heater 12 further comprises a DC-AC conversion means 110 located inside the outer housing or casing 64 of the heater, for converting a received DC power input signal into an AC drive signal for driving the at least one inductor coil 26a, 26b at resonance.

The DC-AC conversion means in this example takes the form of a set of four insulated gate bipolar transistors (IGBTs) 110 connected together in H-bridge configuration. However other DC-AC conversion means may alternatively be used. The DC-AC conversion means is located at one axial end of the water heater, axially adjacent the water receiving space 22.

The heater 12 comprises a power input connector 114 which extends from outside the insulative outer casing 64 of the heater 12 to inside the heater enclosure. The power input connector is for example for receiving a DC power input signal from outside of the heater. The power input connector is electrically connected to a filter capacitor 118, which in this example is advantageously arranged extending co-axially around the outside of housing 14 which encloses the water receiving space 22. As discussed in relation to embodiments above, this housing is preferably electrically and thermally conductive, and preferably forms one 32 of the conductive tubes arranged to become inductive heated upon driving of the inductor coils 26a, 26b.

The filter capacitors 118 filter the high frequency pulsations generated by the DC-AC conversion means 110, isolating these from the power input connector 114, and in use, any electrically upstream components from the power input connector, such as a generator.

As a result, a stable, non-pulsating DC electrical signal will then be transported through the power cable toward the point of use heater 12.

The filter capacitor 118 is however optional and may be omitted in alternative examples, in which case the input DC power signal may be routed straight to the DC-AC conversion means 110.

The filter capacitor 118 is electrically connected to the DC-AC conversion means 110, such that the DC-AC conversion means receives from the filter capacitors the filtered DC power input signal. The DC-AC conversion means converts this received DC signal into an output AC drive signal for actively driving the inductor coils 26a, 26b. More particularly it preferably generates an output AC drive signal having a frequency substantially matching the resonance frequency of the resonance circuit comprised of the inductor coils 26a, 26b, and the connected capacitor 62 (referred to herein as a resonant capacitor).

The AC drive signal generated by the DC-AC conversion means 110 is routed to the resonant circuit comprising the inductor coils 26a, 26b and connected resonant capacitor 62, to thereby drive the inductor coils for thereby causing inductive heating of the conductive tubes 30a, 30b, 32 in use.

Electrical connections between components of the heater are facilitated at least in part by means of a PCB 122, to which at least a portion of the components are connected.

This heater is thus suitable for receiving a DC power input signal, and generating an AC drive signal for driving the coils. The water heater in accordance with this set of embodiments may be suitable for example for use within a water heating system which comprises a generator arrangement located remote from each of one or more point of use heaters (for example remote from the point of use area of each heater unit), and wherein the central generator performs some or all of the electrical processing required in generating the drive signal for supply to the at least one inductor coil, for driving the coil at resonance.

For example this heater may be suitable for use within a heating system having a remote generator in which the remote generator for example processes an incoming mains supply into a rectified DC signal, and then supplies this DC signal as a DC power input signal for each of one or more point of use heaters comprised by the system.

Similar to the filter capacitors 118, the resonant capacitor 62 is in this example advantageously arranged wrapped co-axially around the outside of the conductive outer housing 14, this housing forming an outer-most one 32 of the conductive tubes.

The resonant capacitor 62 and filter capacitors 118 are thermally coupled with the water receiving space 22 via the thermally and electrically conductive outer housing 14. They are thermally coupled to, but electrically isolated from the outer housing. They may be arranged in direct physical contact with the outer housing, with, for example an electrically insulative outer covering of the capacitor electrically isolating it from the housing.

There may also be provided a mechanical protective casing 120 for the capacitors 62, 118 located within the electrically insulative outer casing 64. The outer casing 64 encloses around the full assembly of electrical components and the water receiving space.

The IGBTs of the DC-AC conversion means 110 are arranged in thermal communication with the water receiving space 22, for transferring heat to water flowing through said water receiving space between the inlet 18 and outlet 20.

More particularly, IGBTs 110 are arranged in thermal communication with the water receiving space via a heat transfer element 112 having at least a portion arranged for making contact with the water flowing in use between the inlet and the outlet. The heat transfer element comprises a thermally conductive body which has a heat output surface in contact with water flowing through the heater, and thermally couples the IGBTs with the water in use, while keeping the IGBTs electrically isolated from the water. The heat transfer element provides a heat sink for the IGBTs.

The heat transfer element 112 and the IGBTs 110 of the inverter are shown in more detail in FIG. 22. In this example, the heat transfer element 112 is in the form of a metal block with external square or rectangular cross section. The inverter components (the IGBTs) are coupled to different respective outer surfaces of the block. The heat transfer element features a central longitudinal bore 116, such that the coupled inverter components 110a-110d are arranged annularly around this bore, and thermally coupled to an inner surface of the bore via the heat transfer element body.

The heat transfer element 112 may, by way of one example, be formed of a stainless steel or aluminium. There may be provided an electrical insulation material between each IGBT (or other transistor elements) and the heat transfer element surface. The heat transfer element, in use, is preferably in thermal connection with the IGBTs and, simultaneously, in thermal communication with the flowing water.

The heat transfer element 112 is arranged such that the central bore 116 forms a water flow channel arranged for receiving water flowing in from the inlet 18. Thus the incoming relatively cold water flows through the bore of the heat transfer element, prior to entering the water heating space 22 in which the inductor coils 26a, 26b and the conductive tubes 30a, 30b, 32 are located. Heat is thus transferred away from the IGBTs into the water.

By placing the DC-AC conversion means 110, the resonant capacitor 62 and the filter capacitor 118 in thermal communication with the water, two advantages are achieved. First, cooling of these devices is performed, thus negating the need for any auxiliary cooling means to cool the components. Second, the otherwise wasted heat dissipated by these components is efficiently harnessed for contributing to the heating of the flowing water.

DC-AC inverters typically present heat losses due to the switching efficiency and due to Joule heating. These losses are typically dependent on the switching frequency, the calibration of the frequency to the required resonant frequency, and the electrical current. In high power applications, these inverters (typically H-bridge IGBTs) often require external means of cooling. These are often fan and heat sinks for low and medium power applications and water coolers for medium to high power applications.

By advantageously placing the inverter in the point of use heater and in thermal contact with the flowing water via an electrically insulating heat sink, the need for auxiliary active cooling means is avoided.

In addition to the thermal efficiency benefits, the location of these components at the point of use (and preferably inside the heater outer casing 64) enables important electrical and safety benefits. By placing the inductor coils 26, the resonant capacitor 62, and the DC-AC conversion means within the point of use area, all high frequency alternating currents will be confined to this space.

The external diameter of the heater housing and electrically insulative outer casing 64 has been increased for the present set of embodiments (compared to that of FIGS. 12-13 for example) to accommodate the two capacitors 62, 118 and the mechanical protection cover 120 over them. This also provides the required space at the inlet end to accommodate the DC-AC inverter heat transfer element 112 and the inverter components 110 as well as the power printed circuit board (PCB) 122 that features power and drive signal connections. This power PCB is advantageously thermally coupled to an exterior surface of the outer housing 14 of the water receiving space, for example the cover member 33a. This provides cooling for the PCB.

In use, the incoming water in this advantageous embodiment firstly flows through the bore 116 of the heat transfer element 112, efficiently cooling the main DC-AC converter 110 components installed in thermal contact with the heat transfer element 112. It then flows into the water receiving space 22, firstly passing through an initial upper area, arranged in thermal contact with the power PCB 122 via cover member 33a. This enables extraction of waste heat generated by the PCB.

Water then flows through the outer-most annular flow channel 28a, beneficially cooling the resonant capacitor 62 and the filter capacitor 118 as it passes, these components being arranged in thermal communication with the outer housing 14 (outer conductive tube 32) as discussed. Water will also absorb heat generated by the inductor coil 26a and the two conductive tubes 32, 30a through driving of coils with the AC drive signal. The remainder of the flow path is substantially identical to previously described embodiments, and so will not be described in detail.

The arrangement of the conductor tubes 30a, 30b, and inductor coils 26a, 26b and also the flow channel arrangement defined by the conductor tubes within the water receiving space 22 are all the same as in the example of FIGS. 1 and 2, and FIGS. 19 and 20. These will therefore not be discussed in detail again here. All details and options described above in relation to the example of FIGS. 1 and 2 may be applied also to the present embodiment.

Further options will now be described which may be applied to any of the above described embodiments.

When a wire or conductor is driven with a high frequency alternating current, a so-called skin effect occurs, wherein current density through the wire is concentrated at a radial periphery of the wire. This has the effect that Joule heating in the wire is maximized at regions toward the radial periphery, i.e. toward the radial outer surface (or ‘skin’) of the wire.

This has two effects. First, the maximum temperature to which the wire is heated is increased as the current is concentrated in a smaller volume toward this periphery, instead of across the whole wire cross-section. Secondly, due to concentration of Joule heating at the periphery, heat transfer out of the wire (both radiative, convective and conductive), is increased as more of the heat is concentrated at areas more thermally proximal the radial surface.

In typical inductive heating devices, both of these effects cause problems for the inductor coil winding, as they increase the burden on heat dissipation means for keeping the coil cool.

According to embodiments of the present invention, these effects are beneficial, since the internal heat generated by the coil is actively used for the heating of the water and hence enhanced thermal transfer out of the conductive line of the coil is advantageous. In embodiments of the present invention, the skin effect occurs in both the inductor coil, but also correspondingly in the conductor tubes 30a, 30b inductively stimulated by the coil. Hence both elements benefit from surface-concentrated heating.

According to one or more particular examples, the at least one inductor coil may be driven with an alternating current having frequency of at least 10 kHz, preferably at least 20 kHz, more preferably at least 40 kHz, even more preferably at least 60 kHz. These high frequencies help facilitate the skin effect.

As noted above, in typical inductive heating devices, it is desired to minimize the above-described skin-effect in the inductor coil, in which current is concentrated toward a radial surface of the inductor coil wire. At least partially for this end, typically copper is used for the coil material. Copper has high electrical conductivity and is non-magnetic. These two properties minimize the skin effect.

According to embodiments of the present invention, it may be beneficial to enhance the skin effect. At least partially for this purpose, according to one or more embodiments, the inductor coil may be formed from a magnetic stainless steel material, e.g. martensitic or ferritic stainless steel. Many example materials within the group of martensitic stainless steels will be known to the skilled person.

More broadly, Joule heating may be enhanced in the inductor coil by providing the inductor coil(s) and/or the conductor tubes (or other conductive bodies) formed of any high resistivity magnetic material (high compared for instance to copper). Martensitic stainless steels represent one group of such materials.

According to any embodiment of the present invention, the heater may further comprise a temperature sensor for sensing temperature of water within the water receiving unit. Outputs of the sensor may be used by a further provided controller for instance to regulate the drive signal provided to the inductive coils 26a, 26b.

An example temperature sensor 78 is illustrated in the example of FIG. 12. The temperature sensor is disposed at an outlet 20 end of the water receiving space 22. Two temperature sensing wires or probes 80 are provided extending across the water outlet for sensing the temperature of water as it leaves the heater (i.e. after it has been heated).

A control loop may be implemented whereby the frequency, duty or power supplied to the inductor coils is varied in dependence upon a sensed temperature of the water, with the power being increased for cooler water, and decreased for hotter water. In this way, over-heating of the water can be avoided. The control loop may be configured to maintain the water at a defined temperature, or within a defined range, for instance defined by a thermostat setting.

Due to the instantaneous nature of the heating which is provided by point of use heaters, water temperature adjustments can be performed extremely rapidly. There is no lag-time normally associated with tank based systems. Furthermore, the induction based heating mechanism also allows for rapid temperature adjustments, since the main source of heat (induction) can be altered almost instantaneously. Unlike with traditional resistive heating elements for instance, lag time waiting for the heating element to cool after the current is removed is substantially reduced.

According to one or more embodiments, at least the one or more conductive bodies (e.g. conductive tubes 30a, 30b 32) of the heater may be formed of a magnetic material having a magnetic relative permeability of at least 800. This very high magnetic permeability allows for conductor targets (e.g. tubes 30) to be provided of very low thickness (e.g. less than 1 mm) while still maintaining high magnetic induction responsiveness in the targets.

By contrast, in known arrangements, the conductive targets are provided of a certain minimum thickness to enable sufficient ‘pick-up’ of magnetic fields in the targets and thereby avoid interaction between opposed inductor coil turns. By instead increasing magnetic permeability, this thin body problem can be avoided, allowing for much thinner conductor targets and thus substantial weight and material use reductions.

Advantageously, according to one or more embodiments, the water heater 12 may be further powered by a battery capable of powering the inductor coil(s) 26 for a certain period. The battery may be configured to recharge during periods when sufficient mains power is available. Providing a battery connected in parallel with or instead of the mains input allows the unit to run on its own power. This is useful for instance to allow multiple heating units in a given dwelling to run at the same time without overloading the dwelling power draw limit. One or more of the units may run temporarily, either totally or partially, on the battery power.

The battery may be provided remote from the heater 12 according to certain examples, and electrically connected to the heater for supplying power when needed. A single battery may service more than one heater in a building or dwelling for instance.

A high performance lithium battery may for example be used.

In use, a point of use water heater 12 according to any embodiment of the present invention may installed in-line with an existing cold-water feed, or installed within a water tap or water tap unit for instance. The water heater can be installed directly adjacent, i.e. directly upstream from, the particular water outlet point which is to be supplied by the unit. The unit draws water directly from this cold water feed and outputs hot water, heated substantially instantaneously by the unit.

Examples in accordance with a further aspect of the present invention provide a water heating system comprising: a plurality of water outlets for providing outflow of water; and

a respective point-of-use water heater in accordance with any embodiment or example described above or in accordance with any claim of this application, the water heater installed in-line with each of said water outlets for supplying each outlet with heated water.

The plurality of water outlets of the water heating system may be hot water supply points, i.e. supply points where water may be drawn from the system e.g. by a user, for use by the user. Each inductor heater is installed in-line with one of the plurality of water outlets (or water supply points), meaning it is installed for instance in-line with a water supply pipe leading to the water outlet (or supply point) for heating water as it passes through said pipe en route to the respective water outlet of the system.

Examples in accordance with a further aspect provide a water heating system comprising:

one or more water outlets for providing outflow of water;

a respective point-of-use water heater 12 in accordance with any example or embodiment outlined above or described below, or in accordance with any claim of this application, installed in-line with each of said water outlets for supplying each outlet with heated water; and

a remote or central generator arrangement, arranged in electrical communication with each of the respective point-of-use water heaters, and configured to provide a power supply signal to each of the heaters for electrically powering at least the driving of the at least one inductor coil of each heater.

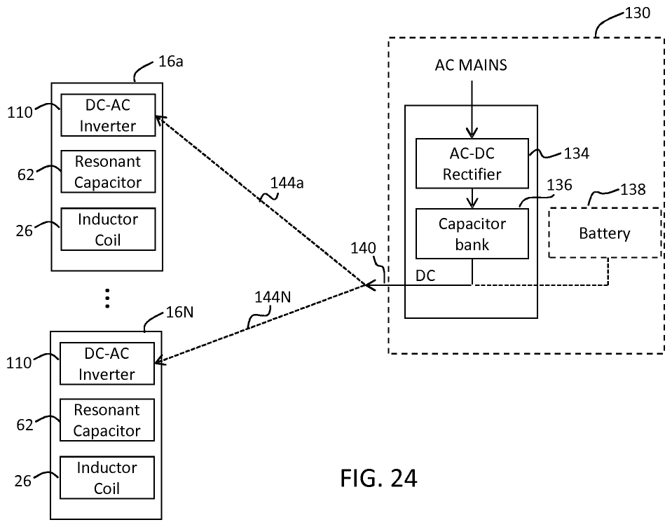

The electrical configuration of one example water heating system in accordance with one set of embodiments is schematically illustrated in FIG. 24.

The system comprises a remote central generator arrangement 130 located in a convenient central location, remote from each of a set of N point of use water heaters, each installed locally in-line with a respective water outlet (not shown). The system comprises at least one water heater, but preferably a plurality of water heaters.

Each respective water heater 12 and connected water outlet are located within a respective point of use area, and the generator 130 is located in a generator area, the generator area for example being remote from each point of use area. Purely by way of example, it may for instance be spaced from each point of use area by a distance of at least 2 m, for example at least 3 m, for example at least 5 m.

In the illustrated example, the remote generator arrangement 130 is configured to output a DC power supply signal to each water heater, and each heater is configured for receiving a DC power input signal from the generator and processing this to generate an AC drive signal for driving the inductor coils of the heater. Each heater 12 may by way of example be a heater in accordance with the embodiment of FIGS. 19-23.

The central generator arrangement 130 receives a mains AC power input. The generator comprises an AC-DC conversion means (an AC-DC rectifier) 134 configured to convert said AC power input into an output DC power supply signal for provision to each of the respective water heaters 12. The generator preferably further comprises a bank of DC smoothing capacitors 136 electrically connected between the AC-DC rectifier 134 and the output connector 140 of the generator arrangement 130. This acts to smooth or even out fluctuations in the output DC signal. A smoothing capacitor is a well-known electrical component, and the skilled person will know how to implement this component.

The central generator arrangement 130 is electrically connected to each of the one or more point of use heaters 12, preferably by one or more connecting wires 144, such that each heater is arranged to receive the DC power supply signal output from the generator arrangement.

In this example system, each point of use heater 12 comprises a DC-AC conversion means 110 configured to transform the received DC power supply signal into an AC drive signal having a frequency suitable for driving the inductor coils 26. The inductor coils are coupled to a capacitor 62 to form a resonant circuit with the capacitor. The AC drive signal may be generated having a frequency substantially matching a resonance frequency of said resonant circuit.

Thus, the elements transforming the DC signal into a high frequency AC drive signal are located in close proximity to or within each point of use heater unit 12, rather than located at the central generator. This means that the high frequency alternating electrical signal transmission is limited to the point of use area, more preferably to inside the heater enclosure.

Furthermore, the AC-DC rectifier is located centrally, meaning that there is no need for a separate high power mains connection to be provided to each heater 12. A single mains connection can be provided to the central generator. The heaters do not include any AC-DC conversion means between the power input connection of each heater and the DC-AC conversion means.

The cable or any other electrical connection means 144 that transports the electrical power from the induction generator 130 to the point of use heater 12 may, in this described embodiment, transport the power in a DC pulsating form, which limits the potential external electromagnetic induction hazard. The cable or any other electrical transport device may be provided with electromagnetic shielding in this case to prevent the cable causing interference in surrounding devices. High frequency pulsation, despite its DC nature (non-alternating), may induce noise and/or heating into the surrounding equipment and structures.

In further advantageous examples, each water heater 12 may further comprise an electrical filter means, such as one or more filter capacitors, electrically connected between the DC power input point of the heater and the DC-AC conversion means 110. This inhibits transmission of AC signal components from the DC-AC conversion means toward the input connector.

In this way the high frequency pulsations will be filtered out from the electrically upstream components of the system, i.e. the cable 144, and the power mains and components of the generator. A stable, non-pulsating DC electrical signal will then be transported through the cable connecting the generator and the point of use heater, advantageously avoiding the need for any specially shielded or coaxial cables. This is also optimal from a safety point of view.

Although in the particular example system of FIG. 24, the DC-AC conversion means 110 is positioned locally at each point of use heater, this is not essential. In an alternative set of embodiments for example, DC-AC conversion means may be provided at the central generator arrangement 130, such that the generator arrangement generates an AC drive signal suitable for driving the inductor coils 26 of each point of use heater. This signal is then transported to each heater via the electrical connection 144. In this case, the heaters do not include any DC-AC conversion means between the power input connection of each heater and the resonant circuit comprising the inductor coils 26 and the resonant capacitor 62. In this set of embodiments, each heater may be a heater in accordance with the embodiment of FIGS. 12-13 for example.

In accordance with either embodiment, the central generator may in advantageous examples optionally include an auxiliary battery 138. This may be provided connected in parallel with the smoothing capacitor bank 136. The battery is preferably a lithium battery, preferably having a power rating of at least 12 KW, preferably between 12-16 KW, and preferably having a charge capacity of at least 120 Ah and more preferably between 120-200 Ah.

The battery 138 can be used to supplement the primary mains power supply during periods of high demand, e.g. when multiple water heaters 12 are drawing power from the generator 130 simultaneously. For example, in a domestic dwelling, at periods of high demand, required total water heating power may be between 18-24 KW. For example a typical domestic gas boiler has a maximum power output of 24 KW. This power draw may exceed the maximum possible mains power draw of the dwelling. The battery thus may allow the mains power to be supplemented at times of peak demand.

Smart charging of the battery may be implemented. For example, the generator arrangement 130 may comprise control means, e.g. a controller or processor, configured for selectively implementing
a charging mode in which the battery 138 is charged via power received through the primary main power input, and said primary power input is used for generating each of said power supply signal(s) for provision to each of the respective water heaters 12; and
a battery draw mode in which stored power in the battery is used as a secondary power input for use in generating each of said respective power supply signals, either alone or in addition to the primary power input.

In accordance with preferred embodiments, the water heating system may comprise a control means (either the same or different to the above control means) configured for controlling the AC frequency of the AC drive signal supplied to the resonant circuit of each water heater 12 for driving the at least one inductor coil of each. The AC drive signal is output by a DC-AC conversion means 110 which may be located centrally at the remote generator 130, or a separate DC-AC conversion means may be included as part of each heater. In either case, the control means may control generation of one or more guide signals indicative of a target AC frequency output of the DC-AC conversion means, wherein the DC-AC conversion means is adapted to generate an output AC drive signal in accordance with the guide signal indicated frequency.

This control means may be centrally located at the remote generator arrangement 130, and wherein the one or more guide signals are communicated to each of the one or more heaters via a wired or wireless connection.

Alternatively, at least part of the control means 130 may be distributed among the one or more water heaters 12.

The system may further comprise a user interface device permitting a user to adjust one or more settings related to operation of the heaters. For example, the system may permit a user-controllable maximum power of each heater 12, and/or a maximum water temperature of each heater. These may be implemented by the central generator by means of regulating the power level of the output power supply signal provided to each heater.

The control means may comprise a processor being loaded with a computer program configured when executed for implementing the various control and/or battery charging functions discussed in this disclosure.

Optionally, the remote generator arrangement 130 may for example be located in a different room to each of the point of use water heaters 12. It may optionally be located at a minimum distance from each of the water heaters, for instance at least 2 m from each of the water heaters, for example at least 3 m from each of the water heaters, for example at least 5 m from each of the water heaters.

Examples in accordance with a further aspect of the invention provide a point of use induction water heating method for heating water in-line with a water supply pipe, the method comprising:

receiving water into a water receiving space 22, the water receiving space arranged between an inlet 18 and an outlet 20;

driving at least one inductor coil 26a, 26b contained in the water receiving space 22 and arranged for making contact with (and/or to be submerged by) water flowing in use between the inlet 18 and the outlet 20 with a current to thereby magnetically induce electrical currents in at least one conductive body contained in the water receiving space for heating the conductive body, and to thereby heat water flowing in use between the inlet 18 and outlet 20.

As discussed above, certain embodiments make use of a controller or control means. The controller or control means can be implemented in numerous ways, with software and/or hardware, to perform the various functions required. A processor is one example of a controller which employs one or more microprocessors that may be programmed using software (e.g., microcode) to perform the required functions. A controller may however be implemented with or without employing a processor, and also may be implemented as a combination of dedicated hardware to perform some functions and a processor (e.g., one or more programmed microprocessors and associated circuitry) to perform other functions.

Examples of controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more storage media such as volatile and non-volatile computer memory such as RAM, PROM, EPROM, and EEPROM. The storage media may be encoded with one or more programs that, when executed on one or more processors and/or controllers, perform the required functions. Various storage media may be fixed within a processor or controller or may be transportable, such that the one or more programs stored thereon can be loaded into a processor or controller.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A point of use induction water heater for installation in-line with a water supply pipe, for heating water flowing through the water heater between an inlet and an outlet thereof, the water heater comprising:
a water receiving space arranged between the inlet and outlet;
at least one inductor coil contained in the water receiving space and being configured, in use, to be in contact with and to be submerged by water flowing between the inlet and the outlet; and
at least one electrically conductive body contained in the water receiving space, and configured for magnetic inducement therein of electrical currents through driving of the at least one inductor coil, the electrical currents for heating the conductive body, to thereby heat water flowing in use between the inlet and outlet.

2.-15. (canceled)

16. A water heater as claimed in claim 1, wherein the water heater further comprises a capacitor electrically coupled with the at least one inductor coil, to thereby form a resonant circuit with the at least one inductor coil, the resonant circuit having an electrical resonance frequency.

17. (canceled)

18. (canceled)

19. A water heater as claimed in claim 16, wherein the capacitor is arranged in thermal communication with the water receiving space for transferring heat to water flowing through said water receiving space between the inlet and outlet.

20. A water heater as claimed in claim 19, wherein
the water receiving space is enclosed by an electrically conductive housing, an interior surface of the housing arranged to contact water passing through the water receiving space between the inlet and the outlet, and the housing configured to be inductively heated in use by the at least one inductor coil upon driving of current through the at least one inductor coil, and
the capacitor is arranged wrapped co-axially around the outside of electrically conductive housing, in thermal communication with, but electrical isolation from, the housing.

21. A water heater as claimed in claim 19, wherein the capacitor is contained within the water receiving space, electrically insulated from water flowing through the space, and in thermal communication with passing water.

22. A water heater as claimed in claim 21, wherein the capacitor defines an annular shape with a central bore, and the capacitor arranged in the water receiving space such that the central bore defines a water flow channel arranged for receiving water flowing between the inlet and the outlet, and optionally wherein the water heater further comprises an array of radial heat dissipation fins within the central bore, thermally coupled to the capacitor, for coupling heat to water passing through the central bore.

23.-25. (canceled)

26. A water heater as claimed in claim 16, wherein:
the water heater comprises a power input connector for receiving a DC power input from outside the water heater,
the water heater comprises a local DC-AC conversion means configured to receive and transform the DC power input into an AC electrical drive signal for driving the at least one inductor coil, and
the water heater is configured to provide said AC electrical drive signal to the resonant circuit for driving the at least one inductor coil.

27. A water heater as claimed in claim 26, wherein said AC electrical drive signal has a frequency matching said electrical resonance frequency of the resonant circuit.

28. A water heater as claimed in claim 26, wherein the DC-AC conversion means comprises one or more transistors, the one or more transistors preferably being insulated gate bipolar transistors (IGBTs).

29. A water heater as claimed in claim 26, wherein:
the water heater comprises an electrical filter means electrically connected between the DC-AC conversion means and the power input connector, and configured to inhibit transmission of AC signal components from the DC-AC conversion means toward the power input connector; or
the DC power input signal is a pulsed DC power input signal, and the DC-AC conversion means is configured for transforming said pulsed DC power input signal into said AC drive signal for driving the at least one inductor coil.

30. (canceled)

31. A water heater as claimed in claim 26, wherein the water heater includes a heat dissipation means thermally coupled to the DC-AC conversion means, and adapted to dissipate heat generated by the DC-AC conversion means.

32. A water heater as claimed in claim 26, wherein the DC-AC conversion means is arranged in thermal communication with the water receiving space, for transferring heat to water flowing through said water receiving space between the inlet and outlet.

33. A water heater as claimed in claim 32, wherein the DC-AC conversion means is arranged in thermal communication with the water receiving space via a heat transfer element of which at least a portion is arranged for making contact with the water flowing in use between the inlet and the outlet.

34. A water heater as claimed in claim 33, wherein the heat transfer element is shaped to define a central bore, and arranged such that the central bore defines a water flow channel arranged, in use, for receiving water flowing between the inlet and the outlet, for transferring heat from the DC-AC conversion means to the water passing through the water flow channel.

35. A water heating system comprising:
one or more water outlets for providing outflow of water;
a respective water heater as claimed in claim 1; installed in-line with each of said one or more water outlets for supplying each water outlet with heated water; and
a remote generator arrangement, arranged in electrical communication with each of the respective water heaters, and configured to provide a power supply signal to each of the respective water heaters for electrically powering at least the driving of the at least one inductor coil of each water heater.

36. A water heating system as claimed in claim 35, wherein the remote generator arrangement is configured to output a DC power supply signal to each respective water heater, and preferably wherein the remote generator arrangement is arranged to receive an AC power input and comprises AC-DC conversion means configured to convert said AC power input into an output DC power supply signal for provision to each of the respective water heaters.

37. (canceled)

38. A water heating system as claimed in claim 35, wherein:
the remote generator arrangement comprises a primary power input for receiving input power from outside the generator, and further comprises one or more batteries; and
the remote generator arrangement comprises control means configured for selectively implementing:
a charging mode in which a battery is charged via power received through the primary power input, and said primary power input is used for generating each of said power supply signal(s) for provision to each of the respective water heaters; and
a battery draw mode in which stored power in the battery is used as a secondary power input for use in generating each of said respective power supply signals, either alone or in addition to the primary power input.

39. A water heating system comprising:
a plurality of water outlets for providing outflow of water; and
a respective point-of-use water heater as claimed in claim 1 installed in-line with each of said water outlets for supplying each water outlet with heated water.

40. (canceled)
